(19) United States
(12) Patent Application Publication
(10) Pub. No.: US 2026/0049217 A1
(43) Pub. Date: Feb. 19, 2026

(54) DYED ARTICLES FOR VISIBLE LIGHT FILTERING

(71) Applicant: Oakley, Inc., Foothill Ranch, CA (US)

(72) Inventors: Drew R. HEITZ, Columbus, OH (US); Paul A. CAHILL, Dayton, OH (US)

(73) Assignee: Oakley, Inc., Foothill Ranch, CA (US)

(21) Appl. No.: 19/369,636

(22) Filed: Oct. 27, 2025

Related U.S. Application Data
(63) Continuation of application No. PCT/US2024/060539, filed on Dec. 17, 2024.
(60) Provisional application No. 63/626,169, filed on Jan. 29, 2024.

(51) Int. Cl. C09B 23/04; C08K 5/3432; G02C 7/10

(52) U.S. Cl. CPC C09B 23/04; C08K 5/3432; G02C 7/108

(57) ABSTRACT

Harmful light sources in the range from about 430 nm to about 470 nm are finding an increased use for marking, engraving, and cutting various materials. One such source of harmful light are lasers. Protection from laser hazards, including blue and violet wavelength laser sources, is an increasing need as applications for and use of both continuous wave and pulsed lasers continues to grow. Articles for laser protection and other harmful light sources can take many forms, such a shield, a lens, a window, a lid, a cover, a case, a plaque, a sheet, a film, clothing, a panel, a curtain, and articles in varying shapes that offer protection. Laser protection and protection from other harmful light sources (natural and artificial) can be achieved with protective articles that comprise at least one dye according to Formula I.

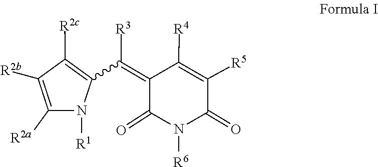

### CROSS REFERENCE TO RELATED APPLICATIONS

This application is a continuation of PCT/US2024/060539 filed Dec. 17, 2024, which claims the benefit of U.S. Provisional Patent Application No. 63/626,169, filed Jan. 29, 2024, which are hereby incorporated by reference in their entireties.

### FIELD

The present disclosure provides dyed articles comprising dyes for protection from visible wavelength light hazards, for example, from laser diodes and other sources of harmful light, in the range of about 430 nm to about 470 nm, while maintaining high visible light transmission.

### BACKGROUND

Harmful light can come from the sun and artificial sources. Harmful light sources are finding an increased use for marking, engraving, and cutting various materials. One such source of harmful light is lasers. Protection against laser hazards, including blue and violet wavelength laser sources, is an increasing need as applications for and use of both continuous wave and pulsed lasers continue to grow. At visible wavelengths, bright blue and violet laser sources in the range from about 430 nm to about 470 nm (e.g. blue and violet laser diodes) may vary with design and drift with laser temperature. Therefore, broad wavelength protection is required. But a broad wavelength protective article creates challenges as it tends to reduce the transmission of visible light, making it difficult for the wearer of the protective article to see effectively. Accordingly, there is a need in the art for protective dyes and protective articles that include at least one protective dye capable of filtering hazardous light wavelengths while preserving visible light transmission.

### BRIEF SUMMARY

In one aspect, the present disclosure is directed to a dye of Formula I

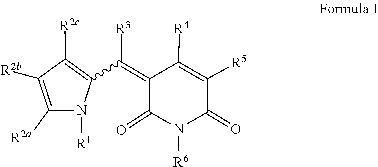

wherein
R¹ is H, C₁-C₆ alkyl, C₃-C₆ cycloalkyl, C₁-C₆ haloalkyl, (CH₂)ₙCO₂R⁷, (CH₂)ₙC(O)NHR⁷, alkylene-CN, or alkylene-aryl;
R^{2a}, R^{2b}, and R^{2c} are each independently H, halo, C₁-C₆ alkyl, C₃-C₆ cycloalkyl, aryl, alkylene-aryl, (CH₂)ₙCO₂R⁷, or C(O)NHR⁸;
R³ is H, C₁-C₆ alkyl, C₃-C₆ cycloalkyl, C₁-C₆ haloalkyl, aryl, (CH₂)ₙCO₂R⁷, or (CH₂)ₙC(O)NHR⁷;
R⁴ is H, C₁-C₆ alkyl, C₃-C₆ cycloalkyl, C₁-C₆ haloalkyl, aryl, (CH₂)ₙCO₂R⁷, or (CH₂)ₙC(O)NHR⁷ and R⁵ is CN; or R⁴ and R⁵, taken together with the carbons that they are attached to, form an aryl ring;
R⁶ is H, C₁-C₆ alkyl, C₃-C₆ cycloalkyl, C₁-C₆ haloalkyl, aryl, alkylene-CO₂R⁷, alkylene-C(O)NHR⁷, or C₁-C₁₂ alkylene-R¹⁰,
R⁷ is H or C₁-C₆ alkyl;
R⁸ is H, C₁-C₆ alkyl, or (CH₂)ₘ(R⁹)₂;
R⁹ is H, C₁-C₆ alkyl;
R¹⁰ is

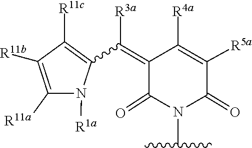

provided that when R⁶ is C₁-C₁₂ alkylene-R¹⁰, R^{1a} is identical to R¹, R^{11a} is identical to R^{2a}, R^{11b} is identical to R^{2b}, R^{11c} is identical to R^{2c}, R^{3a} is identical to R³, R^{4a} is identical to R⁴, and R^{5a} is identical to R⁵;
each n is independently at each occurrence 0, 1, 2, 3, or 4; and
m is 1, 2, 3, or 4.

In another aspect, the compound of the disclosure is a compound having Formula I, wherein
R¹ is H, C₁-C₆ alkyl, C₁-C₆ haloalkyl, (CH₂)ₘaryl, (CH₂)ₙCO₂R⁷, or (CH₂)ₘCN;
R^{2a}, R^{2b}, and R^{2c} are each independently H, halo, C₁-C₆ alkyl, C₃-C₆ cycloalkyl, aryl, (CH₂)ₙCO₂R⁷, or C(O)NHR⁸,
R³ is H, C₁-C₆ alkyl, C₃-C₆ cycloalkyl;
R⁴ is C₁-C₆ alkyl and R⁵ is CN; or R⁴ and R⁵, taken together with the carbons that they are attached to, form an aryl ring;
R⁶ is H or C₁-C₆ alkyl;
R⁷ is H, C₁-C₆ alkyl;
R⁸ is H, C₁-C₆ alkyl, or (CH₂)ₘ(R⁹)₂;
R⁹ is H, C₁-C₆ alkyl;
each n is independently at each occurrence 0, 1, 2, 3, or 4; and
each m is independently at each occurrence 1, 2, 3, or 4.

In another aspect, the compound of the disclosure is a compound having Formula I, wherein
R¹ is H, methyl, ethyl, n-butyl, t-butyl, (CH₂)₃CF₃, CH₂CO₂R⁷, or CH₂CN, or

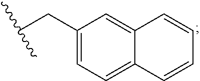 [SMILES: *Cc1ccc2ccccc2c1]

R^{2a}, R^{2b}, and R^{2c} are each independently H, methyl, ethyl, n-butyl, t-butyl, or CO₂R⁷;
R³ is H;
R⁴ is methyl and R⁵ is CN or R⁴ and R⁵, taken together with the carbons that they are attached to, form an aryl ring;
R⁶ is H or ethyl; and
R⁷ is H or C₁-C₆ alkyl.

In another aspect, the compound of the disclosure is a compound having Formula I, wherein
R¹ is H, methyl, ethyl, n-butyl, or t-butyl;
R^{2a}, R^{2b}, and R^{2c} are each independently H, methyl, ethyl, n-butyl, or t-butyl;
R³ is H;
R⁴ is methyl;
R⁵ is CN; and
R⁶ is H or ethyl.

In another aspect, the compound of the disclosure is
5-((4-(tert-butyl)-1H-pyrrol-2-yl)methylene)-1-ethyl-4-methyl-2,6-dioxo-1,2,5,6-tetrahydropyridine-3-carbonitrile;
5-((3,5-dimethyl-1H-pyrrol-2-yl)methylene)-1-ethyl-4-methyl-2,6-dioxo-1,2,5,6-tetrahydropyridine-3-carbonitrile;
5-((1H-pyrrol-2-yl)methylene)-1-ethyl-4-methyl-2,6-dioxo-1,2,5,6-tetrahydropyridine-3-carbonitrile;
ethyl-5-((5-cyano-1-ethyl-4-methyl-2,6-dioxo-1,6-dihydropyridin-3(2H)-ylidene)methyl)-2,4-dimethyl-1H-pyrrole-3-carboxylate;
5-((5-cyano-1-ethyl-4-methyl-2,6-dioxo-1,6-dihydropyridin-3(2H)-ylidene)methyl)-2,4-dimethyl-1H-pyrrole-3-carboxylic acid;
5-((5-cyano-1-ethyl-4-methyl-2,6-dioxo-1,6-dihydropyridin-3(2H)-ylidene)methyl)-N-(2-(diethylamino)ethyl)-2,4-dimethyl-1H-pyrrole-3-carboxamide;
ethyl-5-((5-cyano-1-ethyl-4-methyl-2,6-dioxo-1,6-dihydropyridin-3(2H)-ylidene)methyl)-1H-pyrrole-2-carboxylate;
5-((1H-pyrrol-2-yl)methylene)-4-methyl-2,6-dioxo-1,2,5,6-tetrahydropyridine-3-carbonitrile;
tetrahydropyridine-3-carbonitrile;
5-((3,5-dimethyl-1H-pyrrol-2-yl)methylene)-4-methyl-2,6-dioxo-1,2,5,6-tetrahydropyridine-3-carbonitrile;
1-ethyl-4-methyl-5-((1-methyl-1H-pyrrol-2-yl)methylene)-2,6-dioxo-1,2,5,6-tetrahydropyridine-3-carbonitrile;
5-((4-(tert-butyl)-1-butyl-1H-pyrrol-2-yl)methylene)-1-ethyl-4-methyl-2,6-dioxo-1,2,5,6-tetrahydropyridine-3-carbonitrile;
5-((4-(tert-butyl)-1-(naphthalen-2-ylmethyl)-1H-pyrrol-2-yl)methylene)-1-ethyl-4-methyl-2,6-dioxo-1,2,5,6-tetrahydropyridine-3-carbonitrile;
ethyl (Z)-5-((5-cyano-4-methyl-2,6-dioxo-1,6-dihydropyridin-3(2H)-ylidene)methyl)-1-(cyanomethyl)-2,4-dimethyl-1H-pyrrole-3-carboxylate;
4-((1H-pyrrol-2-yl)methylene)isoquinoline-1,3(2H,4H)-dione;
4-((4-(tert-butyl)-1H-pyrrol-2-yl)methylene)isoquinoline-1,3(2H,4H)-dione;
4-((3,5-dimethyl-1H-pyrrol-2-yl)methylene)isoquinoline-1,3(2H,4H)-dione;
5-((4-(tert-butyl)-1-(4,4,4-trifluorobutyl)-1H-pyrrol-2-yl)methylene)-1-ethyl-4-methyl-2,6-dioxo-1,2,5,6-tetrahydropyridine-3-carbonitrile;
5-((4-(tert-butyl)-1-(4,4,4-trifluorobutyl)-1H-pyrrol-2-yl)methylene)-4-methyl-2,6-dioxo-1,2,5,6-tetrahydropyridine-3-carbonitrile;
ethyl (Z)-2-(4-(tert-butyl)-2-((5-cyano-1-ethyl-4-methyl-2,6-dioxo-1,6-dihydropyridin-3 (2H)-ylidene)methyl)-1H-pyrrol-1-yl) acetate; or
5-((4-(tert-butyl)-1-(cyanomethyl)-1H-pyrrol-2-yl)methylene)-4-methyl-2,6-dioxo-1,2,5,6-tetrahydropyridine-3-carbonitrile.
In another aspect, the compound of the disclosure is
(Z)-5-((4-(tert-butyl)-1H-pyrrol-2-yl)methylene)-1-ethyl-4-methyl-2,6-dioxo-1,2,5,6-tetrahydropyridine-3-carbonitrile;
(Z)-5-((3,5-dimethyl-1H-pyrrol-2-yl)methylene)-1-ethyl-4-methyl-2,6-dioxo-1,2,5,6-tetrahydropyridine-3-carbonitrile;
(Z)-5-((1H-pyrrol-2-yl)methylene)-1-ethyl-4-methyl-2,6-dioxo-1,2,5,6-tetrahydropyridine-3-carbonitrile;
ethyl (Z)-5-((5-cyano-1-ethyl-4-methyl-2,6-dioxo-1,6-dihydropyridin-3(2H)-ylidene)methyl)-2,4-dimethyl-1H-pyrrole-3-carboxylate;
(Z)-5-((5-cyano-1-ethyl-4-methyl-2,6-dioxo-1,6-dihydropyridin-3(2H)-ylidene)methyl)-2,4-dimethyl-1H-pyrrole-3-carboxylic acid;
(Z)-5-((5-cyano-1-ethyl-4-methyl-2,6-dioxo-1,6-dihydropyridin-3(2H)-ylidene)methyl)-N-(2-(diethylamino)ethyl)-2,4-dimethyl-1H-pyrrole-3-carboxamide;
ethyl (Z)-5-((5-cyano-1-ethyl-4-methyl-2,6-dioxo-1,6-dihydropyridin-3(2H)-ylidene)methyl)-1H-pyrrole-2-carboxylate;
(Z)-5-((1H-pyrrol-2-yl)methylene)-4-methyl-2,6-dioxo-1,2,5,6-tetrahydropyridine-3-carbonitrile;
(Z)-5-((4-(tert-butyl)-1H-pyrrol-2-yl)methylene)-4-methyl-2,6-dioxo-1,2,5,6-tetrahydropyridine-3-carbonitrile;
(Z)-5-((3,5-dimethyl-1H-pyrrol-2-yl)methylene)-4-methyl-2,6-dioxo-1,2,5,6-tetrahydropyridine-3-carbonitrile;
(Z)-1-ethyl-4-methyl-5-((1-methyl-1H-pyrrol-2-yl)methylene)-2,6-dioxo-1,2,5,6-tetrahydropyridine-3-carbonitrile;
(Z)-5-((4-(tert-butyl)-1-butyl-1H-pyrrol-2-yl)methylene)-1-ethyl-4-methyl-2,6-dioxo-1,2,5,6-tetrahydropyridine-3-carbonitrile;
(Z)-5-((4-(tert-butyl)-1-(naphthalen-2-ylmethyl)-1H-pyrrol-2-yl)methylene)-1-ethyl-4-methyl-2,6-dioxo-1,2,5,6-tetrahydropyridine-3-carbonitrile;
ethyl (Z)-5-((5-cyano-4-methyl-2,6-dioxo-1,6-dihydropyridin-3(2H)-ylidene)methyl)-1-(cyanomethyl)-2,4-dimethyl-1H-pyrrole-3-carboxylate;
(Z)-4-((1H-pyrrol-2-yl)methylene)isoquinoline-1,3(2H,4H)-dione;
(Z)-4-((4-(tert-butyl)-1H-pyrrol-2-yl)methylene)isoquinoline-1,3(2H,4H)-dione;
(Z)-4-((3,5-dimethyl-1H-pyrrol-2-yl)methylene)isoquinoline-1,3(2H,4H)-dione;
(Z)-5-((4-(tert-butyl)-1-(4,4,4-trifluorobutyl)-1H-pyrrol-2-yl)methylene)-1-ethyl-4-methyl-2,6-dioxo-1,2,5,6-tetrahydropyridine-3-carbonitrile;
(Z)-5-((4-(tert-butyl)-1-(4,4,4-trifluorobutyl)-1H-pyrrol-2-yl)methylene)-4-methyl-2,6-dioxo-1,2,5,6-tetrahydropyridine-3-carbonitrile;
ethyl (Z)-2-(4-(tert-butyl)-2-((5-cyano-1-ethyl-4-methyl-2,6-dioxo-1,6-dihydropyridin-3 (2H)-ylidene)methyl)-1H-pyrrol-1-yl) acetate; or
(Z)-5-((4-(tert-butyl)-1-(cyanomethyl)-1H-pyrrol-2-yl)methylene)-4-methyl-2,6-dioxo-1,2,5,6-tetrahydropyridine-3-carbonitrile.
In another aspect, the compound of the disclosure is
(E)-5-((4-(tert-butyl)-1H-pyrrol-2-yl)methylene)-1-ethyl-4-methyl-2,6-dioxo-1,2,5,6-tetrahydropyridine-3-carbonitrile;
(E)-5-((3,5-dimethyl-1H-pyrrol-2-yl)methylene)-1-ethyl-4-methyl-2,6-dioxo-1,2,5,6-tetrahydropyridine-3-carbonitrile;
(E)-5-((1H-pyrrol-2-yl)methylene)-1-ethyl-4-methyl-2,6-dioxo-1,2,5,6-tetrahydropyridine-3-carbonitrile;
ethyl (Z)-5-((5-cyano-1-ethyl-4-methyl-2,6-dioxo-1,6-dihydropyridin-3(2H)-ylidene)methyl)-2,4-dimethyl-1H-pyrrole-3-carboxylate;
(E)-5-((5-cyano-1-ethyl-4-methyl-2,6-dioxo-1,6-dihydropyridin-3(2H)-ylidene)methyl)-2,4-dimethyl-1H-pyrrole-3-carboxylic acid;
(E)-5-((5-cyano-1-ethyl-4-methyl-2,6-dioxo-1,6-dihydropyridin-3(2H)-ylidene)methyl)-N-(2-(diethylamino)ethyl)-2,4-dimethyl-1H-pyrrole-3-carboxamide;
ethyl (E)-5-((5-cyano-1-ethyl-4-methyl-2,6-dioxo-1,6-dihydropyridin-3(2H)-ylidene)methyl)-1H-pyrrole-2-carboxylate;
(E)-5-((1H-pyrrol-2-yl)methylene)-4-methyl-2,6-dioxo-1,2,5,6-tetrahydropyridine-3-carbonitrile;
(E)-5-((4-(tert-butyl)-1H-pyrrol-2-yl)methylene)-4-methyl-2,6-dioxo-1,2,5,6-tetrahydropyridine-3-carbonitrile;
(E)-5-((3,5-dimethyl-1H-pyrrol-2-yl)methylene)-4-methyl-2,6-dioxo-1,2,5,6-tetrahydropyridine-3-carbonitrile;
(E)-1-ethyl-4-methyl-5-((1-methyl-1H-pyrrol-2-yl)methylene)-2,6-dioxo-1,2,5,6-tetrahydropyridine-3-carbonitrile;
(E)-5-((4-(tert-butyl)-1-butyl-1H-pyrrol-2-yl)methylene)-1-ethyl-4-methyl-2,6-dioxo-1,2,5,6-tetrahydropyridine-3-carbonitrile;
(E)-5-((4-(tert-butyl)-1-(naphthalen-2-ylmethyl)-1H-pyrrol-2-yl)methylene)-1-ethyl-4-methyl-2,6-dioxo-1,2,5,6-tetrahydropyridine-3-carbonitrile;
ethyl (E)-5-((5-cyano-4-methyl-2,6-dioxo-1,6-dihydropyridin-3(2H)-ylidene)methyl)-1-(cyanomethyl)-2,4-dimethyl-1H-pyrrole-3-carboxylate;
(E)-4-((1H-pyrrol-2-yl)methylene)isoquinoline-1,3(2H,4H)-dione;
(E)-4-((4-(tert-butyl)-1H-pyrrol-2-yl)methylene)isoquinoline-1,3(2H,4H)-dione;
(E)-4-((3,5-dimethyl-1H-pyrrol-2-yl)methylene)isoquinoline-1,3(2H,4H)-dione;
(E)-5-((4-(tert-butyl)-1-(4,4,4-trifluorobutyl)-1H-pyrrol-2-yl)methylene)-1-ethyl-4-methyl-2,6-dioxo-1,2,5,6-tetrahydropyridine-3-carbonitrile;
(E)-5-((4-(tert-butyl)-1-(4,4,4-trifluorobutyl)-1H-pyrrol-2-yl)methylene)-4-methyl-2,6-dioxo-1,2,5,6-tetrahydropyridine-3-carbonitrile;
ethyl (E)-2-(4-(tert-butyl)-2-((5-cyano-1-ethyl-4-methyl-2,6-dioxo-1,6-dihydropyridin-3 (2H)-ylidene)methyl)-1H-pyrrol-1-yl) acetate; or
(E)-5-((4-(tert-butyl)-1-(cyanomethyl)-1H-pyrrol-2-yl)methylene)-4-methyl-2,6-dioxo-1,2,5,6-tetrahydropyridine-3-carbonitrile.

In one aspect, the present disclosure is directed to a dyed article comprising a polymer material and at least one dye of Formula I.

In some aspects, the at least one dye of Formula I is selected from the group consisting of
5-((3,5-dimethyl-1H-pyrrol-2-yl)methylene)-1-ethyl-4-methyl-2,6-dioxo-1,2,5,6-tetrahydropyridine-3-carbonitrile;
5-((1H-pyrrol-2-yl)methylene)-4-methyl-2,6-dioxo-1,2,5,6-tetrahydropyridine-3-carbonitrile;
5-((1H-pyrrol-2-yl)methylene)-1-ethyl-4-methyl-2,6-dioxo-1,2,5,6-tetrahydropyridine-3-carbonitrile;
5-((4-(tert-butyl)-1H-pyrrol-2-yl)methylene)-1-ethyl-4-methyl-2,6-dioxo-1,2,5,6-tetrahydropyridine-3-carbonitrile;
5-((4-(tert-butyl)-1H-pyrrol-2-yl)methylene)-4-methyl-2,6-dioxo-1,2,5,6-tetrahydropyridine-3-carbonitrile;
5-((3,5-dimethyl-1H-pyrrol-2-yl)methylene)-4-methyl-2,6-dioxo-1,2,5,6-tetrahydropyridine-3-carbonitrile;
4-((1H-pyrrol-2-yl)methylene)isoquinoline-1,3(2H,4H)-dione;
4-((4-(tert-butyl)-1H-pyrrol-2-yl)methylene)isoquinoline-1,3(2H,4H)-dione; and
4-((3,5-dimethyl-1H-pyrrol-2-yl)methylene)isoquinoline-1,3(2H,4H)-dione as exclusively the (Z) isomer, exclusively the (E) isomer, or a combination of both the (Z) and the (E) isomer.

In some aspects, the at least one dye of Formula I is selected from the group consisting of
5-((3,5-dimethyl-1H-pyrrol-2-yl)methylene)-1-ethyl-4-methyl-2,6-dioxo-1,2,5,6-tetrahydropyridine-3-carbonitrile;
5-((1H-pyrrol-2-yl)methylene)-4-methyl-2,6-dioxo-1,2,5,6-tetrahydropyridine-3-carbonitrile;
5-((1H-pyrrol-2-yl)methylene)-1-ethyl-4-methyl-2,6-dioxo-1,2,5,6-tetrahydropyridine-3-carbonitrile;
5-((3,5-dimethyl-1H-pyrrol-2-yl)methylene)-4-methyl-2,6-dioxo-1,2,5,6-tetrahydropyridine-3-carbonitrile;
4-((1H-pyrrol-2-yl)methylene)isoquinoline-1,3(2H,4H)-dione; and
4-((3,5-dimethyl-1H-pyrrol-2-yl)methylene)isoquinoline-1,3(2H,4H)-dione
   as exclusively the (Z) isomer, exclusively the (E) isomer, or a combination of both the (Z) and the (E) isomer.

In another aspects, the present disclosure is directed to the dyed article, wherein the dyed article is in the form of a shield, a lens, a window, a lid, a cover, a case, a plaque, a sheet, a film, clothing, a panel, and a curtain.

In another aspects, the present disclosure is directed to the dyed article, wherein the polymer material is selected from the group consisting of an acrylic resin, a styrenic resin, a cellulosic resin, a polyamide resin, a polycarbonate resin, a polyester resin, a polyethylene resin, a polyimide resin, and a polyurethane resin.

In another aspects, the present disclosure is directed to the dyed article, wherein the polymer material is crosslinked.

In another aspects, the present disclosure is directed to the dyed article, wherein the dyed article has an optical density of at least about 12 from about 430 nm to about 470 nm and internal visual luminous transmission of no more than about 85% using the methods described in ANSI Standard Z80.3 and Illuminant C.

In another aspects, the present disclosure is directed to the dyed article, wherein the dyed article has an optical density of at least about 11 from about 430 nm to about 470 nm and internal visual luminous transmission of no more than about 88% using the methods described in ANSI Standard Z80.3 and Illuminant C.

In another aspects, the present disclosure is directed to the dyed article, wherein the dyed article has an optical density of at least about 10 from about 430 nm to about 470 nm and internal visual luminous transmission of no more than about 88% using the methods described in ANSI Standard Z80.3 and Illuminant C.

In another aspects, the present disclosure is directed to the dyed article, wherein the dyed article has an optical density of at least about 9 from about 430 nm to about 470 nm and internal visual luminous transmission of no more than about 89% using the methods described in ANSI Standard Z80.3 and Illuminant C.

In another aspects, the present disclosure is directed to the dyed article, wherein the dyed article has an optical density of at least about 8 from about 430 nm to about 470 nm and internal visual luminous transmission of no more than about 89% using the methods described in ANSI Standard Z80.3 and Illuminant C.

In another aspects, the present disclosure is directed to the dyed article, wherein the dyed article has an optical density of at least about 7 from about 430 nm to about 470 nm and internal visual luminous transmission of no more than about 90% using the methods described in ANSI Standard Z80.3 and Illuminant C.

In another aspects, the present disclosure is directed to the dyed article, wherein the dyed article has an optical density of at least about 6 from about 430 nm to about 470 nm and internal visual luminous transmission of no more than about 90% using the methods described in ANSI Standard Z80.3 and Illuminant C.

In another aspects, the present disclosure is directed to the dyed article, wherein the dyed article has an optical density of at least about 5 from about 430 nm to about 470 nm and internal visual luminous transmission of no more than about 91% using the methods described in ANSI Standard Z80.3 and Illuminant C.

In another aspects, the present disclosure is directed to the dyed article, wherein the dyed article has an optical density of at least about 4 from about 430 nm to about 470 nm and internal visual luminous transmission of no more than about 92% using the methods described in ANSI Standard Z80.3 and Illuminant C.

In another aspects, the present disclosure is directed to the dyed article, wherein the dyed article has an optical density of at least about 3 from about 430 nm to about 470 nm and internal visual luminous transmission of no more than about 93% using the methods described in ANSI Standard Z80.3 and Illuminant C.

In another aspects, the present disclosure is directed to the dyed article, wherein the dyed article has an optical density of at least about 2 from about 430 nm to about 470 nm and internal visual luminous transmission of no more than about 94% using the methods described in ANSI Standard Z80.3 and Illuminant C.

In one aspect, the present disclosure is directed to a process of preparing the dyed article, comprising coating, casting, extruding, or molding the polymer material and the at least one dye.

In one aspect, the present disclosure is directed to a method for making the dye of Formula I, the method comprising:

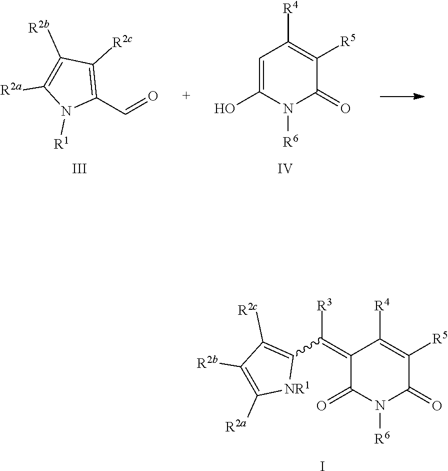

reacting a compound of Formula III with a compound of Formula IV in a solvent in the presence of a base catalyst while maintaining a reaction temperature of about room temperature to about 50° C., wherein
R¹ is H, C₁-C₆ alkyl, C₃-C₆ cycloalkyl, C₁-C₆ haloalkyl, (CH₂)ₙCO₂R⁷, (CH₂)ₙC(O)NHR⁷, alkylene-CN, or alkylene-aryl; and
R^{2a}, R^{2b}, and R^{2c} are each independently H, halo, C₁-C₆ alkyl, C₃-C₆ cycloalkyl, aryl, (CH₂)ₙCO₂R⁷, or C(O)NHR⁸;
R³ is H, C₁-C₆ alkyl, C₃-C₆ cycloalkyl, C₁-C₆ haloalkyl, aryl, (CH₂)ₙCO₂R⁷, or (CH₂)ₙC(O)NHR⁷;
R⁴ is H, C₁-C₆ alkyl, C₃-C₆ cycloalkyl, C₁-C₆ haloalkyl, aryl, (CH₂)ₙCO₂R⁷, or (CH₂)ₙC(O)NHR⁷ and R⁵ is CN; or R⁴ and R⁵, taken together with the carbons that they are attached to, form an aryl ring;
R⁶ is H, C₁-C₆ alkyl, C₃-C₆ cycloalkyl, C₁-C₆ haloalkyl, aryl, alkylene-CO₂R⁷, or alkylene-C(O) NHR⁷;
R⁷ is H or C₁-C₆ alkyl;
R⁸ is H, C₁-C₆ alkyl, or (CH₂)ₘ(R⁹)₂;
R⁹ is H or C₁-C₆ alkyl;
each n is independently at each occurrence 0, 1, 2, 3, or 4; and
m is 1, 2, 3, or 4, and
isolating the dye of Formula I.

In another aspects, the present disclosure is directed to a method for making the dye of Formula I, wherein the solvent is ethanol.

In another aspects, the present disclosure is directed to a method for making the dye of Formula I, wherein the base catalyst is piperidine.

Additional aspects and advantages of the disclosure will be set forth, in part, in the description that follows, and will flow from the description, or can be learned by practice of the disclosure.

It is to be understood that both the foregoing summary and the following detailed description are exemplary and explanatory only, and do not restrict the scope of the claims.

### BRIEF DESCRIPTION OF THE DRAWINGS

FIG. 1 illustrates a perspective view of a dyed article, for example a lens, configured to provide protection from harmful light, for example laser hazards, according to some aspects.

FIG. 1A illustrates an aspect of a lens that can be included in an eyewear depicted in FIG. 1.

FIG. 1B illustrates another aspect of a lens that can be included in an eyewear depicted in FIG. 1, the lens comprising an optical filter including a variable filter component and a static filter component.

FIG. 2 depicts internal transmission of Compound 1 in injection molded acrylic. Optical density is greater than about 6.0 from about 430 nm to about 470 nm. Internal visible is about 90% using the methods described in ANSI Standard Z80.3 and Illuminant C.

### DETAILED DESCRIPTION

The headings provided herein are not limitations of the various aspects of the disclosure, which can be defined by reference to the specification as a whole. It is also to be understood that the terminology used herein is for the purpose of describing particular aspects only, and is not intended to be limiting, since the scope of the present disclosure will be limited only by the appended claims.

The present disclosure generally relates to articles for protection from visible wavelength light hazards, for example, from laser diodes, in the range of about 430 nm to about 470 nm, while maintaining high visible light transmission. Protection from visible wavelength light hazard can be achieved with one or more dyes of Formula I, or achieved with a dye of Formula I in combination with one or more secondary dyes.

### Definitions

For convenience, the meaning of some terms and phrases used in the specification, examples, and appended claims are provided below. Unless stated otherwise, or implicit from context, the following terms and phrases include the meanings provided below. The definitions are provided to aid in describing particular aspects, and are not intended to limit the claimed technology, because the scope of the technology is limited only by the claims. Unless otherwise defined, all technical and scientific terms used herein have the same meaning as commonly understood by one of ordinary skill in the art to which this technology belongs. If there is an apparent discrepancy between the usage of a term in the art and its definition provided herein, the definition provided within the specification will control.

The articles “a,” “an,” and “the” are used herein to refer to one or to more than one (i.e., to at least one) of the grammatical object of the article. By way of example, “an element” means one element or more than one element. As used herein, the use of “or” means “and/or” unless expressly stated or understood by one skilled in the art. In the context of a multiple dependent claim, the use of “or” refers back to more than one preceding independent or dependent claim.

As used herein, the term “about” means within an acceptable error range for the particular value as determined by one of ordinary skill in the art, which depends in part on how the value is measured or determined, i.e., the limitations of the measurement system. For example, “about” can mean a range of up to 10% (e.g., up to 5%, or up to 1%) of a given value.

The term “article” as used herein refers to a piece of transparent material (such as glass, polycarbonate, polyurethane, resin, etc.), for example, cast, extruded, or molded polymer shapes, including shapes with varying geometry. The term can refer to products that are used for eye, face, and general protection including but not limited to a shield, a lens, a window, a lid, a cover, a case, a plaque, a sheet, a film, clothing, a panel, and a curtain. In some aspects, the article can be incorporated into eyewear. Eyewear can include but is not limited to general-purpose eyewear, protective eyewear, special-purpose eyewear, sunglasses, face-shields (including eye-shields), eyewear incorporated into a head worn support (such as visors for helmets), visors, driving glasses, sporting glasses, goggles, vision-correcting eyewear, prescription and non-prescription eyeglasses, color vision deficiency eyewear, indoor eyewear, outdoor eyewear, contrast-enhancing eyewear, chroma-enhancing eyewear, color-enhancing eyewear, color-altering eyewear, gaming eyewear, eyewear designed for another purpose, or eyewear designed for a combination of purposes.

The term “dyed” as used herein indicates that an object, e.g., an article, comprises one or more dyes that absorb ultraviolet, visible, and/or infrared light. In some aspects the dye can be a dye of Formula I. In some aspects the dye can comprise at least one dye of Formula I, e.g. at least two, at least three, at least four, at least five, and so on.

The term “alkyl,” used either alone or in compound words such as “haloalkyl” includes straight-chain and branched alkyl, example of which include C₁-C₁₂ alkyls and C₁-C₆ alkyls, such as, methyl, ethyl, n-propyl, i-propyl, and the different butyl, pentyl and hexyl isomers. In some aspects the alkyl group can be optionally substituted.

The term “alkenyl” includes straight-chain and branched alkenes such as ethenyl, 1-propenyl, 2-propenyl, and the different butenyl, pentenyl and hexenyl isomers. In some aspects the alkenyl group can be optionally substituted. The term “alkenyl” also includes polyenes such as 1,2-propadienyl and 2,4-hexadienyl.

The term “alkynyl” refers to straight-chain and branched alkynes such as ethynyl, 1-propynyl, 2-propynyl, and the different butynyl, pentynyl and hexynyl isomers. The term “alkynyl” can also include moieties comprised of multiple triple bonds such as 2,5-hexadiynyl and the like. In some aspects the alkynyl group can be optionally substituted.

The term “alkylene” denotes a straight-chain or branched alkanediyl. Exemplary alkylene groups include, but are not limited to, —CH₂—, —CH₂CH₂—, —CH(CH₃)—, —CH₂CH₂CH₂—, —CH₂CH(CH₃)—, and the different butylene isomers. In some aspects the alkylene group can be optionally substituted.

The term “cycloalkyl” denotes a C3-C12 cycloalkyl or, in certain aspects, a C3-C6 cycloalkyl, for example, cyclopropyl, cyclobutyl, cyclopentyl, or cyclohexyl.

The term “aryl” denotes an aromatic ring system having six to ten carbon atoms, i.e., C6-C10 aryl. Non-limiting exemplary aryl groups include benzyl, phenyl, naphthyl, indenyl, and azulenyl groups. In some aspects the aryl group can be optionally substituted. The term “phenyl” as used herein refers to the radical —C6H5, derived from benzene by removal of a hydrogen atom. Phenyl may also be abbreviated as “Ph.”

The term “cyano” as used herein by itself or as part of another group refers to the group-CN. When used in words such as “cyanoalkyl,” said alkyl can be substituted with one, two, or three-CN groups. Examples of “cyanoalkyl” groups include cyanomethyl, e.g., —CH₂CN, 2-cyanoethyl, e.g., —CH₂CH₂CN, 3-cyanopropyl, e.g., —CH₂CH₂CH₂CN, and 4-cyanobutyl, e.g., —CH₂CH₂CH₂CH₂CN.

The term “halo” either alone or in compound words such as “haloalkyl,” includes fluorine, chlorine, bromine or iodine (i.e. −Cl, −F, −Br, or −I). Further, when used in compound words such as “haloalkyl,” the alkyl can be partially or fully substituted with halo atoms which can be the same or different. Examples of “haloalkyl” groups include, but are not limited to, —CF₃, —CHF₂, —CClH₂, —CF₂Cl, —CFCl₂, —CCl₃, —CF₃CH₂, —CF₃CCl₂, —CH₂CH₂CF₃, —CH₂CH₂CHF₂, —CH₂CF₃, and —CH₂CHF₂.

The term “hydroxyl” or “hydroxyl” either alone or in compound words such as “hydroxyalkyl,” refers to the group-OH. When used in words such as “hydroxyalkyl,” said alkyl can be substituted with one, two, or three-OH groups.

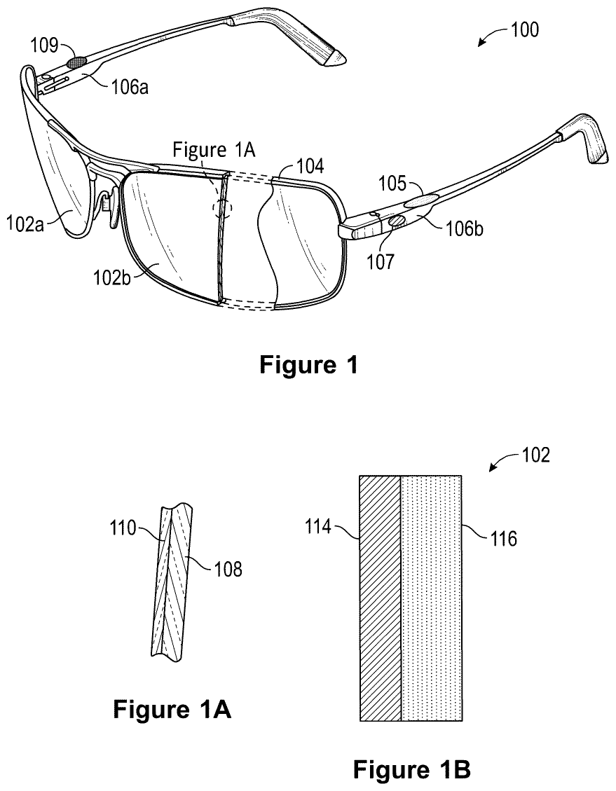

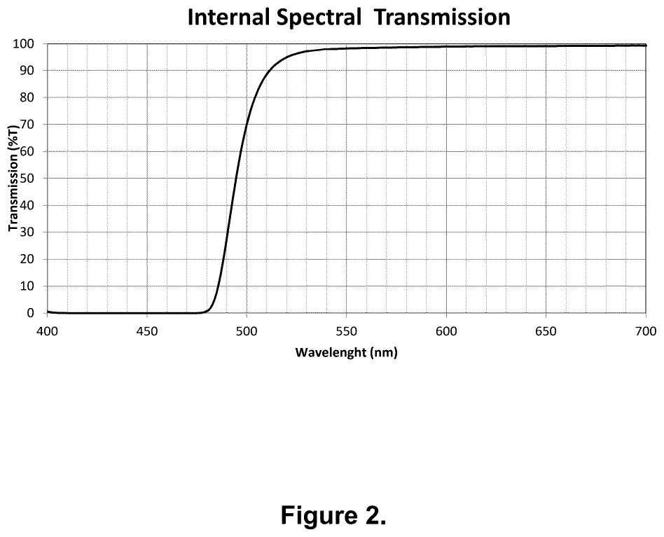

The term “lens” as used herein refers to a piece of transparent material (such as glass, polycarbonate, polyurethane, resin, etc.) that has two opposite regular surfaces either both curved or one curved and the other planar and that is used either singly or combined to form an image. In some aspects, the lens can be a focusing lens. In some aspects, the lens can be a non-focusing lens. The term can refer to lenses used in eyewear including but not limited to general-purpose eyewear, protective eyewear, special-purpose eyewear, sunglasses, face-shields (including eye-shields), eyewear incorporated into headworn support (such as visors for helmets), visors, driving glasses, sporting glasses, goggles, vision-correcting eyewear, prescription and non-prescription eyeglasses, color vision deficiency eyewear, indoor eyewear, outdoor eyewear, contrast-enhancing eyewear, chroma-enhancing eyewear, color-enhancing eyewear, color-altering eyewear, gaming eyewear, eyewear designed for another purpose, or eyewear designed for a combination of purposes. The eyewear can be provided with a unitary lens that is placed in front of both eyes or dual lenses (see, e.g., FIG. 1) with one lens placed in front of each eye when the eyewear is worn.

The phrase “disposed on” means that a first component (e.g., layer) is in direct contact with a second component. A first component “disposed on” a second component can be deposited, formed, placed, or otherwise applied directly onto the second component. In other words, if a first component is disposed on a second component, there are no components between the first component and the second component.

### Blue and Violet Absorbing Dyes

The present disclosure provides blue and violet absorbing pyrrole dioxo-tetrahydropyridine dyes according to Formula I. Dyes according to Formula I can have either E or Z geometry, or can be a mixture of compounds having E and Z geometry:

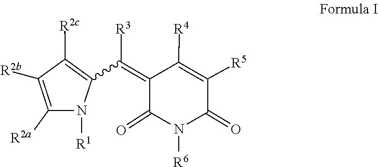

In certain aspects, R¹ is H, C₁-C₆ alkyl, C₃-C₆ cycloalkyl, C₁-C₆ haloalkyl, (CH₂)ₙCO₂R⁷, (CH₂)ₙC(O)NHR⁷, alkylene-CN, or alkylene-aryl;
R^{2a}, R^{2b}, and R^{2c} are each independently H, halo, C₁-C₆ alkyl, C₃-C₆ cycloalkyl, aryl, alkylene-aryl, (CH₂)ₙCO₂R⁷, or C(O)NHR⁸;
R³ is H, C₁-C₆ alkyl, C₃-C₆ cycloalkyl, C₁-C₆ haloalkyl, aryl, (CH₂)ₙCO₂R⁷, or (CH₂)ₙC(O)NHR⁷;
R⁴ is H, C₁-C₆ alkyl, C₃-C₆ cycloalkyl, C₁-C₆ haloalkyl, aryl, (CH₂)ₙCO₂R⁷, or (CH₂)ₙC(O)NHR⁷ and R⁵ is CN; or R⁴ and R⁵, taken together with the carbons that they are attached to, form an aryl ring;
R⁶ is H, C₁-C₆ alkyl, C₃-C₆ cycloalkyl, C₁-C₆ haloalkyl, aryl, alkylene-CO₂R⁷, alkylene-C(O) NHR⁷, or C₁-C₁₂ alkylene-R¹⁰;
R⁷ is H or C₁-C₆ alkyl;
R⁸ is H, C₁-C₆ alkyl, or (CH₂)ₘ(R⁹)₂;
R⁹ is H, C₁-C₆ alkyl;
R¹⁰ is

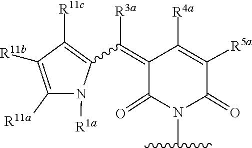

F provided that when R⁶ is C₁-C₁₂ alkylene-R¹⁰, R^{1a} is identical to R¹, R^{11a} is identical to R^{2a}, R^{11b} is identical to R^{2b}, R^{11c} is identical to R^{2c}, R^{3a} is identical to R³, R^{4a} is identical to R⁴, and R^{5a} is identical to R⁵;
each n is independently at each occurrence 0, 1, 2, 3, or 4; and
m is 1, 2, 3, or 4.

In another aspect, R¹ is H, C₁-C₆ alkyl, C₁-C₆ haloalkyl, (CH₂)ₘaryl, (CH₂)ₘCO₂R⁷, or (CH₂)ₘCN;
R^{2a}, R^{2b}, and R^{2c} are each independently H, halo, C₁-C₆ alkyl, C₃-C₆ cycloalkyl, aryl, (CH₂)ₙCO₂R⁷, or C(O)NHR⁸;
R³ is H, C₁-C₆ alkyl, C₃-C₆ cycloalkyl;
R⁴ is C₁-C₆ alkyl and R⁵ is CN; or R⁴ and R⁵, taken together with the carbons that they are attached to, form an aryl ring;
R⁶ is H or C₁-C₆ alkyl;
R⁷ is H, C₁-C₆ alkyl;
R⁸ is H, C₁-C₆ alkyl, or (CH₂)ₘ(R⁹)₂;
R⁹ is H, C₁-C₆ alkyl;
each n is independently at each occurrence 0, 1, 2, 3, or 4; and
each m is independently at each occurrence 1, 2, 3, or 4.

In still further aspects, R¹ is H, methyl, ethyl, n-butyl, t-butyl, (CH₂)₃CF₃, CH₂CO₂R⁷, CH₂CN, or

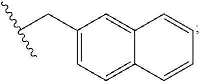 [SMILES: *Cc1ccc2ccccc2c1]

R^{2a}, R^{2b}, and R^{2c} are each independently H, methyl, ethyl, n-butyl, t-butyl, or CO₂R⁷;
R³ is H;
R⁴ is methyl and R⁵ is CN or R⁴ and R⁵, taken together with the carbons that they are attached to, form an aryl ring;
R⁶ is H or ethyl; and
R⁷ is H or C₁-C₆ alkyl.

In yet another aspect, R¹ is H, methyl, n-butyl, CH₂CN, or

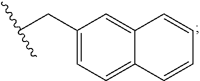 [SMILES: *Cc1ccc2ccccc2c1]

R^{2a}, R^{2b}, and R^{2c} are each independently H, methyl, ethyl, n-butyl, t-butyl, or CO₂R⁷;
R³ is H;
R⁴ is methyl;
R⁵ is CN;
R⁶ is H or ethyl; and
R⁷ is H or ethyl.

In yet another aspect, R¹ is H, methyl, ethyl, n-butyl, or t-butyl;
R^{2a}, R^{2b}, and R^{2c} are each independently H, methyl, ethyl, n-butyl, or t-butyl;
R³ is H;
R⁴ is methyl;
R⁵ is CN; and
R⁶ is H or ethyl.

In yet another aspect, R¹ is (CH₂)₃CF₃, CH₂CO₂R⁷, CH₂CN, or

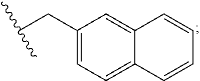 [SMILES: *Cc1ccc2ccccc2c1]

R^{2a}, R^{2b}, and R^{2c} are each independently H, methyl, ethyl, n-butyl, or t-butyl;
R³ is H;
R⁴ is methyl;
R⁵ is CN; and
R⁶ is H or ethyl.

In yet another aspect, R¹ is H;
R^{2a}, R^{2b}, and R^{2c} are each independently H, methyl, ethyl, n-butyl, or t-butyl;
R³ is H;
R⁴ is methyl;
R⁵ is CN; and
R⁶ is ethyl.

In certain aspects, the dye of Formula I can be a compound as set forth in Table 1, below.

TABLE 1
Representative compounds of Formula I

| Compound | | |
|---|---|---|
| No. | Compound Name | Structure |
| 1 | 5-((1H-pyrrol-2-yl)methylene)-1- ethyl-4-methyl-2,6-dioxo-1,2,5,6- tetrahydropyridine-3-carbonitrile | 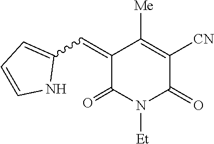 [SMILES: CCN1C(=O)C(=Cc2ccc[nH]2)C(C)=C(C#N)C1=O] |
| 2 | 5-((4-(tert-butyl)-1H-pyrrol-2- yl)methylene)-1-ethyl-4-methyl-2,6- dioxo-1,2,5,6-tetrahydropyridine-3- carbonitrile | 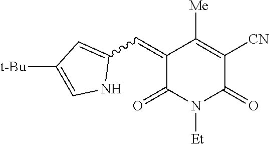 [SMILES: CCN1C(=O)C(=Cc2cc(C(C)(C)C)c[nH]2)C(C)=C(C#N)C1=O] |
| 3 | 5-((3,5-dimethyl-1H-pyrrol-2- yl)methylene)-1-ethyl-4-methyl-2,6- dioxo-1,2,5,6-tetrahydropyridine-3- carbonitrile | 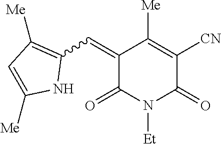 [SMILES: CCN1C(=O)C(=Cc2[nH]c(C)cc2C)C(C)=C(C#N)C1=O] |
| 4 | ethyl 5-((5-cyano-1-ethyl-4-methyl- 2,6-dioxo-1,6-dihydropyridin-3(2H)- ylidene)methyl)-2,4-dimethyl-1H- pyrrole-3-carboxylate | 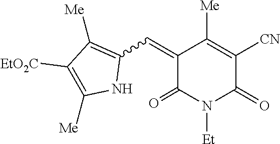 [SMILES: CCOC(=O)c1c(C)[nH]c(C=C2C(=O)N(CC)C(=O)C(C#N)=C2C)c1C] |
| 5 | 5-((5-cyano-1-ethyl-4-methyl-2,6- dioxo-1,6-dihydropyridin-3(2H)- ylidene)methyl)-2,4-dimethyl-1H- pyrrole-3-carboxylic acid | 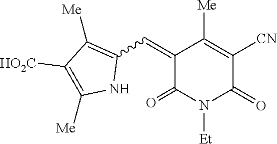 [SMILES: CCN1C(=O)C(=Cc2[nH]c(C)c(C(=O)O)c2C)C(C)=C(C#N)C1=O] |
| 6 | 5-((5-cyano-1-ethyl-4-methyl-2,6- dioxo-1,6-dihydropyridin-3(2H)- ylidene)methyl)-N-(2- (diethylamino)ethyl)-2,4-dimethyl-1H- pyrrole-3-carboxamide | 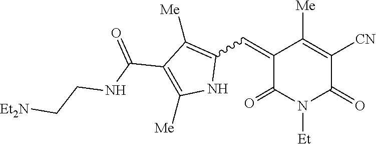 |
| 7 | ethyl 5-((5-cyano-1-ethyl-4-methyl- 2,6-dioxo-1,6-dihydropyridin-3(2H)- ylidene)methyl)-1H-pyrrole-2- carboxylate | 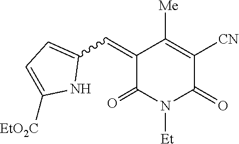 [SMILES: CCOC(=O)c1ccc(C=C2C(=O)N(CC)C(=O)C(C#N)=C2C)[nH]1] |
| 8 | 5-((1H-pyrrol-2-yl)methylene)-4- methyl-2,6-dioxo-1,2,5,6- tetrahydropyridine-3-carbonitrile | 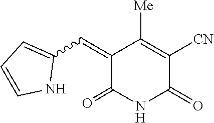 [SMILES: CC1=C(C#N)C(=O)NC(=O)C1=Cc1ccc[nH]1] |
| 9 | 5-((4-(tert-butyl)-1H-pyrrol-2- yl)methylene)-4-methyl-2,6-dioxo- 1,2,5,6-tetrahydropyridine-3- carbonitrile | 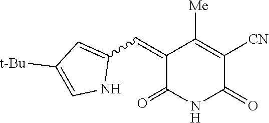 [SMILES: CC1=C(C#N)C(=O)NC(=O)C1=Cc1cc(C(C)(C)C)c[nH]1] |
| 10 | 5-((3,5-dimethyl-1H-pyrrol-2- yl)methylene)-4-methyl-2,6-dioxo- 1,2,5,6-tetrahydropyridine-3- carbonitrile | 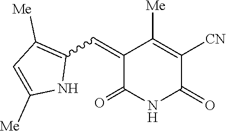 [SMILES: CC1=C(C#N)C(=O)NC(=O)C1=Cc1[nH]c(C)cc1C] |
| 11 | 1-ethyl-4-methyl-5-((1-methyl-1H- pyrrol-2-yl)methylene)-2,6-dioxo- 1,2,5,6-tetrahydropyridine-3- carbonitrile | 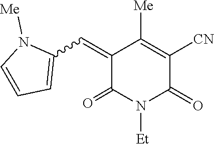 [SMILES: CCN1C(=O)C(=Cc2cccn2C)C(C)=C(C#N)C1=O] |
| 12 | 5-((4-(tert-butyl)-1-butyl-1H-pyrrol-2- yl)methylene)-1-ethyl-4-methyl-2,6- dioxo-1,2,5,6-tetrahydropyridine-3- carbonitrile | 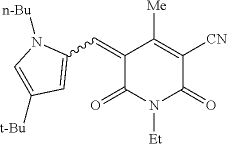 |
| 13 | 5-((4-(tert-butyl)-1-(naphthalen-2- ylmethyl)-1H-pyrrol-2-yl)methylene)- 1-ethyl-4-methyl-2,6-dioxo-1,2,5,6- tetrahydropyridine-3-carbonitrile | 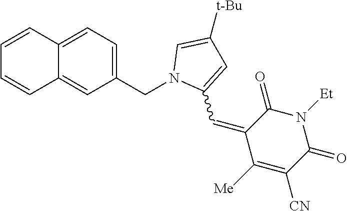 [SMILES: CCN1C(=O)C(=Cc2cc(C(C)(C)C)cn2Cc2ccc3ccccc3c2)C(C)=C(C#N)C1=O] |
| 14 | ethyl 5-((5-cyano-4-methyl-2,6-dioxo- 1,6-dihydropyridin-3(2H)- ylidene)methyl)-1-(cyanomethyl)-2,4- dimethyl-1H-pyrrole-3-carboxylate | 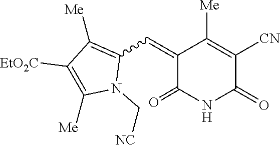 [SMILES: CCOC(=O)c1c(C)c(C=C2C(=O)NC(=O)C(C#N)=C2C)n(CC#N)c1C] |
| 15 | 4-((1H-pyrrol-2- yl)methylene)isoquinoline- 1,3(2H,4H)-dione | 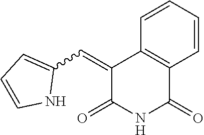 [SMILES: O=C1NC(=O)c2ccccc2C1=Cc1ccc[nH]1] |
| 16 | 4-((4-(tert-butyl)-1H-pyrrol-2- yl)methylene)isoquinoline- 1,3(2H,4H)-dione | 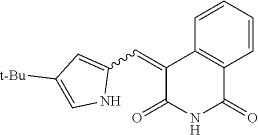 [SMILES: CC(C)(C)c1c[nH]c(C=C2C(=O)NC(=O)c3ccccc32)c1] |
| 17 | 4-((3,5-dimethyl-1H-pyrrol-2- yl)methylene)isoquinoline- 1,3(2H,4H)-dione | 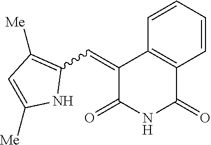 [SMILES: Cc1cc(C)c(C=C2C(=O)NC(=O)c3ccccc32)[nH]1] |
| 18 | 5-((4-(tert-butyl)-1-(4,4,4- trifluorobutyl)-1H-pyrrol-2- yl)methylene)-1-ethyl-4-methyl-2,6- dioxo-1,2,5,6-tetrahydropyridine-3- carbonitrile | 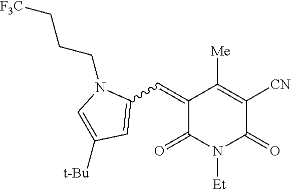 [SMILES: CCN1C(=O)C(=Cc2cc(C(C)(C)C)cn2CCCC(F)(F)F)C(C)=C(C#N)C1=O] |
| 19 | 5-((4-(tert-butyl)-1-(4,4,4- trifluorobutyl)-1H-pyrrol-2- yl)methylene)-4-methyl-2,6-dioxo- 1,2,5,6-tetrahydropyridine-3- carbonitrile | 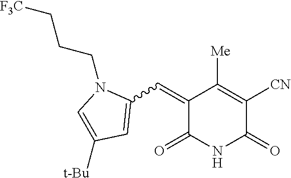 [SMILES: CC1=C(C#N)C(=O)NC(=O)C1=Cc1cc(C(C)(C)C)cn1CCCC(F)(F)F] |
| 20 | ethyl 2-(4-(tert-butyl)-2-((5-cyano-1- ethyl-4-methyl-2,6-dioxo-1,6- dihydropyridin-3(2H)- ylidene)methyl)-1H-pyrrol-1- yl)acetate | 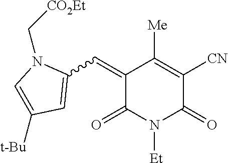 [SMILES: CCOC(=O)Cn1cc(C(C)(C)C)cc1C=C1C(=O)N(CC)C(=O)C(C#N)=C1C] |
| 21 | 5-((4-(tert-butyl)-1-(cyanomethyl)-1H- pyrrol-2-yl)methylene)-4-methyl-2,6- dioxo-1,2,5,6-tetrahydropyridine-3- carbonitrile | 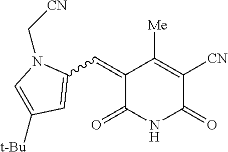 [SMILES: CC1=C(C#N)C(=O)NC(=O)C1=Cc1cc(C(C)(C)C)cn1CC#N] |

In some aspects, the compound of the disclosure is:
(Z)-5-((4-(tert-butyl)-1H-pyrrol-2-yl)methylene)-1-ethyl-4-methyl-2,6-dioxo-1,2,5,6-tetrahydropyridine-3-carbonitrile;
(Z)-5-((3,5-dimethyl-1H-pyrrol-2-yl)methylene)-1-ethyl-4-methyl-2,6-dioxo-1,2,5,6-tetrahydropyridine-3-carbonitrile;
(Z)-5-((1H-pyrrol-2-yl)methylene)-1-ethyl-4-methyl-2,6-dioxo-1,2,5,6-tetrahydropyridine-3-carbonitrile;
ethyl (Z)-5-((5-cyano-1-ethyl-4-methyl-2,6-dioxo-1,6-dihydropyridin-3(2H)-ylidene)methyl)-2,4-dimethyl-1H-pyrrole-3-carboxylate;
(Z)-5-((5-cyano-1-ethyl-4-methyl-2,6-dioxo-1,6-dihydropyridin-3(2H)-ylidene)methyl)-2,4-dimethyl-1H-pyrrole-3-carboxylic acid;
(Z)-5-((5-cyano-1-ethyl-4-methyl-2,6-dioxo-1,6-dihydropyridin-3(2H)-ylidene) methyl)-N-(2-(diethylamino)ethyl)-2,4-dimethyl-1H-pyrrole-3-carboxamide;
ethyl (Z)-5-((5-cyano-1-ethyl-4-methyl-2,6-dioxo-1,6-dihydropyridin-3(2H)-ylidene)methyl)-1H-pyrrole-2-carboxylate;
(Z)-5-((1H-pyrrol-2-yl)methylene)-4-methyl-2,6-dioxo-1,2,5,6-tetrahydropyridine-3-carbonitrile;
(Z)-5-((4-(tert-butyl)-1H-pyrrol-2-yl)methylene)-4-methyl-2,6-dioxo-1,2,5,6-tetrahydropyridine-3-carbonitrile;
(Z)-5-((3,5-dimethyl-1H-pyrrol-2-yl)methylene)-4-methyl-2,6-dioxo-1,2,5,6-tetrahydropyridine-3-carbonitrile;
(Z)-1-ethyl-4-methyl-5-((1-methyl-1H-pyrrol-2-yl)methylene)-2,6-dioxo-1,2,5,6-tetrahydropyridine-3-carbonitrile;
(Z)-5-((4-(tert-butyl)-1-butyl-1H-pyrrol-2-yl)methylene)-1-ethyl-4-methyl-2,6-dioxo-1,2,5,6-tetrahydropyridine-3-carbonitrile;
(Z)-5-((4-(tert-butyl)-1-(naphthalen-2-ylmethyl)-1H-pyrrol-2-yl)methylene)-1-ethyl-4-methyl-2,6-dioxo-1,2,5,6-tetrahydropyridine-3-carbonitrile;
ethyl (Z)-5-((5-cyano-4-methyl-2,6-dioxo-1,6-dihydropyridin-3(2H)-ylidene)methyl)-1-(cyanomethyl)-2,4-dimethyl-1H-pyrrole-3-carboxylate;
(Z)-4-((1H-pyrrol-2-yl)methylene)isoquinoline-1,3(2H,4H)-dione;
(Z)-4-((4-(tert-butyl)-1H-pyrrol-2-yl)methylene)isoquinoline-1,3(2H,4H)-dione;
(Z)-4-((3,5-dimethyl-1H-pyrrol-2-yl)methylene)isoquinoline-1,3(2H,4H)-dione;
(Z)-5-((4-(tert-butyl)-1-(4,4,4-trifluorobutyl)-1H-pyrrol-2-yl)methylene)-1-ethyl-4-methyl-2,6-dioxo-1,2,5,6-tetrahydropyridine-3-carbonitrile;
(Z)-5-((4-(tert-butyl)-1-(4,4,4-trifluorobutyl)-1H-pyrrol-2-yl)methylene)-4-methyl-2,6-dioxo-1,2,5,6-tetrahydropyridine-3-carbonitrile;
ethyl (Z)-2-(4-(tert-butyl)-2-((5-cyano-1-ethyl-4-methyl-2,6-dioxo-1,6-dihydropyridin-3(2H)-ylidene)methyl)-1H-pyrrol-1-yl) acetate; or
(Z)-5-((4-(tert-butyl)-1-(cyanomethyl)-1H-pyrrol-2-yl)methylene)-4-methyl-2,6-dioxo-1,2,5,6-tetrahydropyridine-3-carbonitrile.

In some aspects, the compound of the disclosure is:
(E)-5-((4-(tert-butyl)-1H-pyrrol-2-yl)methylene)-1-ethyl-4-methyl-2,6-dioxo-1,2,5,6-tetrahydropyridine-3-carbonitrile;
(E)-5-((3,5-dimethyl-1H-pyrrol-2-yl)methylene)-1-ethyl-4-methyl-2,6-dioxo-1,2,5,6-tetrahydropyridine-3-carbonitrile;
(E)-5-((1H-pyrrol-2-yl)methylene)-1-ethyl-4-methyl-2,6-dioxo-1,2,5,6-tetrahydropyridine-3-carbonitrile;
ethyl (Z)-5-((5-cyano-1-ethyl-4-methyl-2,6-dioxo-1,6-dihydropyridin-3(2H)-ylidene)methyl)-2,4-dimethyl-1H-pyrrole-3-carboxylate;
(E)-5-((5-cyano-1-ethyl-4-methyl-2,6-dioxo-1,6-dihydropyridin-3(2H)-ylidene)methyl)-2,4-dimethyl-1H-pyrrole-3-carboxylic acid;
(E)-5-((5-cyano-1-ethyl-4-methyl-2,6-dioxo-1,6-dihydropyridin-3(2H)-ylidene) methyl)-N-(2-(diethylamino)ethyl)-2,4-dimethyl-1H-pyrrole-3-carboxamide;
ethyl (E)-5-((5-cyano-1-ethyl-4-methyl-2,6-dioxo-1,6-dihydropyridin-3(2H)-ylidene)methyl)-1H-pyrrole-2-carboxylate;
(E)-5-((1H-pyrrol-2-yl)methylene)-4-methyl-2,6-dioxo-1,2,5,6-tetrahydropyridine-3-carbonitrile;
(E)-5-((4-(tert-butyl)-1H-pyrrol-2-yl)methylene)-4-methyl-2,6-dioxo-1,2,5,6-tetrahydropyridine-3-carbonitrile;
(E)-5-((3,5-dimethyl-1H-pyrrol-2-yl)methylene)-4-methyl-2,6-dioxo-1,2,5,6-tetrahydropyridine-3-carbonitrile;
(E)-1-ethyl-4-methyl-5-((1-methyl-1H-pyrrol-2-yl)methylene)-2,6-dioxo-1,2,5,6-tetrahydropyridine-3-carbonitrile;
(E)-5-((4-(tert-butyl)-1-butyl-1H-pyrrol-2-yl)methylene)-1-ethyl-4-methyl-2,6-dioxo-1,2,5,6-tetrahydropyridine-3-carbonitrile;
(E)-5-((4-(tert-butyl)-1-(naphthalen-2-ylmethyl)-1H-pyrrol-2-yl)methylene)-1-ethyl-4-methyl-2,6-dioxo-1,2,5,6-tetrahydropyridine-3-carbonitrile;
ethyl (E)-5-((5-cyano-4-methyl-2,6-dioxo-1,6-dihydropyridin-3(2H)-ylidene)methyl)-1-(cyanomethyl)-2,4-dimethyl-1H-pyrrole-3-carboxylate;
(E)-4-((1H-pyrrol-2-yl)methylene)isoquinoline-1,3(2H,4H)-dione;
(E)-4-((4-(tert-butyl)-1H-pyrrol-2-yl)methylene)isoquinoline-1,3(2H,4H)-dione;
(E)-4-((3,5-dimethyl-1H-pyrrol-2-yl)methylene)isoquinoline-1,3(2H,4H)-dione;
(E)-5-((4-(tert-butyl)-1-(4,4,4-trifluorobutyl)-1H-pyrrol-2-yl)methylene)-1-ethyl-4-methyl-2,6-dioxo-1,2,5,6-tetrahydropyridine-3-carbonitrile;
(E)-5-((4-(tert-butyl)-1-(4,4,4-trifluorobutyl)-1H-pyrrol-2-yl)methylene)-4-methyl-2,6-dioxo-1,2,5,6-tetrahydropyridine-3-carbonitrile;
ethyl (E)-2-(4-(tert-butyl)-2-((5-cyano-1-ethyl-4-methyl-2,6-dioxo-1,6-dihydropyridin-3(2H)-ylidene)methyl)-1H-pyrrol-1-yl) acetate; or
(E)-5-((4-(tert-butyl)-1-(cyanomethyl)-1H-pyrrol-2-yl)methylene)-4-methyl-2,6-dioxo-1,2,5,6-tetrahydropyridine-3-carbonitrile.

As is apparent from the present disclosure, certain compounds of Formula I can exhibit geometric isomerism that is, the certain compounds have double bonds that can have either “E” or “Z” geometry. If the geometry of a compound disclosed herein is not specified, it is to be understood that the compound is a mixture of E and Z geometric isomers. In some aspects, the compound is a mixture having a ratio of E/Z geometric isomers of from about 1:99 to about 99:1; from about 20:80 to about 80:20; from about 25:75 to about 75:25; from about 40:60 to about 60:40; or about 50:50. In some aspects, the compound is a mixture having a ratio of E/Z geometric isomers of about 1:1. If the geometry of a given compound is specified, it is to be understood that that compound is the pure isomer specified, i.e. 100% E or 100% Z, as the case may be. Accordingly, and in view of the foregoing, a skilled artisan will understand that the present disclosure expressly contemplates and provides mixtures of certain geometric isomers in varying ratios specified above, as well as the pure forms of such compounds free from the other form.

In certain aspects, the dye of Formula I can be a compound as set forth in Table 1, below.

In another aspect, the present disclosure also encompasses intermediates suitable for preparing the compounds according to Formula I, such as pyrrole aldehydes according to Formula III:

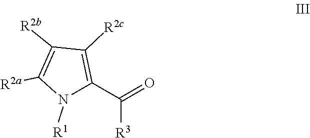

wherein
R¹ is H, C₁-C₆ alkyl, C₃-C₆ cycloalkyl, C₁-C₆ haloalkyl, (CH₂)ₙCO₂R⁷, (CH₂)ₙC(O)NHR⁷, alkylene-CN, or alkylene-aryl;
R^{2a}, R^{2b}, and R^{2c} are each independently H, halo, C₁-C₆ alkyl, C₃-C₆ cycloalkyl, aryl, alkylene-aryl, (CH₂)ₙCO₂R⁷, or C(O)NHR⁸;
R³ is H, C₁-C₆ alkyl, C₃-C₆ cycloalkyl, C₁-C₆ haloalkyl, aryl, (CH₂)ₙCO₂R⁷, or (CH₂)ₙC(O)NHR⁷;
R⁷ is H or C₁-C₆ alkyl;
R⁸ is H, C₁-C₆ alkyl, or (CH₂)ₘ(R⁹)₂;
R⁹ is H, C₁-C₆ alkyl;
each n is independently at each occurrence 0, 1, 2, 3, or 4; and
m is 1, 2, 3, or 4.

### Methods of Making the Protective Dyes

The present disclosure also provides methods of making the dyes described herein. In certain aspects, the method comprises reacting a compound of Formula III with a compound of Formula IV to provide a compound of Formula I, such as in Scheme 1, below.

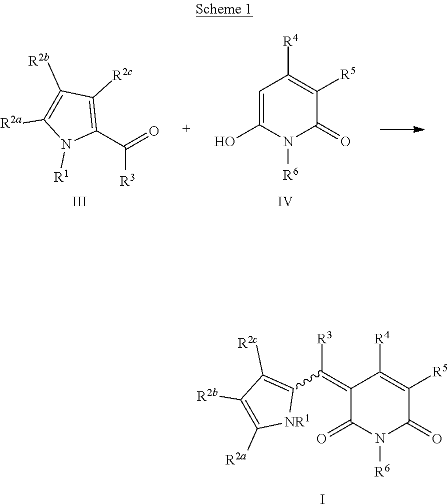

In some aspects, the compounds of Formula I can be prepared by a Knoevenagel-type condensation between a compound of Formula III and a compound of Formula IV (Scheme 1).

In some aspects of the reaction, each of the R groups specified in Scheme 1 has the same meaning as specified elsewhere herein. In particular aspects of the reaction, R¹ is H, C₁-C₆ alkyl, C₃-C₆ cycloalkyl, C₁-C₆ haloalkyl, (CH₂)ₙCO₂R⁷, (CH₂)ₙC(O)NHR⁷, alkylene-CN, or alkylene-aryl;
R^{2a}, R^{2b}, and R^{2c} are each independently H, halo, C₁-C₆ alkyl, C₃-C₆ cycloalkyl, aryl, alkylene-aryl, (CH₂)ₙCO₂R⁷, or C(O)NHR⁸;
R³ is H, C₁-C₆ alkyl, C₃-C₆ cycloalkyl, C₁-C₆ haloalkyl, aryl, (CH₂)ₙCO₂R⁷, or (CH₂)ₙC(O)NHR⁷;
R⁴ is H, C₁-C₆ alkyl, C₃-C₆ cycloalkyl, C₁-C₆ haloalkyl, aryl, (CH₂)ₙCO₂R⁷, or (CH₂)ₙC(O)NHR⁷ and R⁵ is CN; or R⁴ and R⁵, taken together with the carbons that they are attached to, form an aryl ring;
R⁶ is H, C₁-C₆ alkyl, C₃-C₆ cycloalkyl, C₁-C₆ haloalkyl, aryl, alkylene-CO₂R⁷, or alkylene-C(O) NHR⁷;
R⁷ is H or C₁-C₆ alkyl;
R⁸ is H, C₁-C₆ alkyl, or (CH₂)ₘ(R⁹)₂;
R⁹ is H, C₁-C₆ alkyl;
each n is independently at each occurrence 0, 1, 2, 3, or 4; and
m is 1, 2, 3, or 4.

In some aspects, the reaction of the compound of Formula III with the compound of Formula IV can take place in a solvent selected from the group consisting of methanol, ethanol, dichloromethane, ethyl acetate, cyclopentyl methyl ether, and toluene. In particular aspects, the solvent is ethanol.

In some aspects, the reaction of the compounds of Formulas III and IV takes place in the presence of a catalytic amount of base. In certain aspects, the base is selected from the group consisting of piperidine and pyridine. In other aspects, the base used in the reaction between the compounds of Formulas III and IV is piperidine.

In another aspect, the present disclosure relates to a process of preparing compounds of Formula III (Scheme 2):

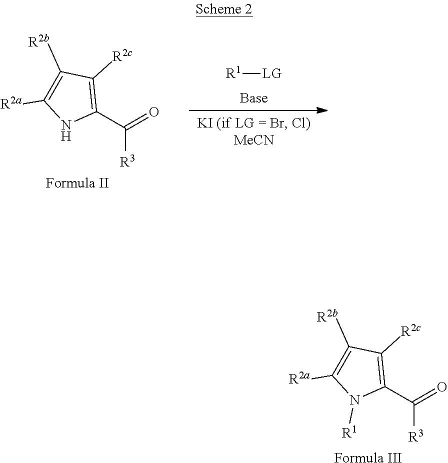

In some aspects, the compounds of Formula III can be prepared by an S_{N}1 or S_{N}2 reaction of an amine according to Formula II, with R¹-LG, wherein LG is a leaving group such as, but not limited to, I, Br, Cl, mesylate, or tosylate. In some aspects, LG is I, Br, or Cl. In some aspects, the preparation of compounds of Formula III takes place in the presence of a catalytic amount of KI when LG is Br or Cl.

In some aspects, the preparation of compounds of Formula III takes place in the presence of base. In certain aspects, the base is selected from K₂CO₃, triethyl amine, and sodium hydride. In other aspects, the base used in the preparation of compounds of Formula III is K₂CO₃.

In some aspects of the reaction for preparing compounds of Formula III, R¹ is H, C₁-C₆ alkyl, C₃-C₆ cycloalkyl, C₁-C₆ haloalkyl, (CH₂)ₙCO₂R⁷, (CH₂)ₙC(O)NHR⁷, alkylene-CN, or alkylene-aryl;
R^{2a}, R^{2b}, and R^{2c} are each independently H, halo, C₁-C₆ alkyl, C₃-C₆ cycloalkyl, aryl, alkylene-aryl, (CH₂)ₙCO₂R⁷, or C(O)NHR⁸,
R³ is H, C₁-C₆ alkyl, C₃-C₆ cycloalkyl, C₁-C₆ haloalkyl, aryl, (CH₂)ₙCO₂R⁷, or (CH₂)ₙC(O)NHR⁷;
R⁷ is H or C₁-C₆ alkyl;
R⁸ is H, C₁-C₆ alkyl, or (CH₂)ₘ(R⁹)₂;
R⁹ is H, C₁-C₆ alkyl;
each n is independently at each occurrence 0, 1, 2, 3, or 4; and
m is 1, 2, 3, or 4.
   Articles for Protection from Visible Wavelength Light Hazards

The present disclosure further provides articles for protection comprising one or more dyes of Formula I. In some aspects, the article can comprise a lens comprising the dye of Formula I. The dye of Formula I can be incorporated into the lens in any acceptable manner that results in protection from visible wavelength light in the range of about 430 nm to about 470 nm.

In certain aspects the article can be a shield, a lens, a window, a lid, a cover, a case, a plaque, a sheet, a film, clothing, a panel, and a curtain. In certain aspects, the article can be incorporated into eyewear. In certain aspects, eyewear can include but is not limited to general-purpose eyewear, protective eyewear, special-purpose eyewear, sunglasses, face-shields (including eye-shields), eyewear incorporated into headworn support (such as visors for helmets), visors, driving glasses, sporting glasses, goggles, vision-correcting eyewear, prescription and non-prescription eyeglasses, color vision deficiency eyewear, indoor eyewear, outdoor eyewear, contrast-enhancing eyewear, chroma-enhancing eyewear, color-enhancing eyewear, color-altering eyewear, gaming eyewear, eyewear designed for another purpose, or eyewear designed for a combination of purposes.

In certain aspects, the lens can comprise an optical filter comprising the dye of Formula I. In some aspects, the optical filter comprising the dye of Formula I can be incorporated into a lens having any desired curvature, including, for example, cylindrical, plano, spherical or toroidal. In some aspects, the lens can include one or more functional components, such as, for example, layers, coatings, or laminates. Examples of functional components include, but are not limited to, color enhancement filters, chroma enhancement filters, laser attenuation filters, electrochromic filters, photoelectrochromic filters, polarizing filter, variable attenuation filters, anti-reflection coatings, interference stacks, hard coatings, flash mirrors, anti-static coatings, anti-fog coatings, blue cut dye layers, deep red absorbing dye layers, and broadly absorbing dye layers, other functional layers, or a combination of functional layers. In some aspects, the lens can include a lens body and the optical filter comprising the dye of Formula I.

In some aspects, a lens including a lens body and an optical filter comprising the dye of Formula I within and/or outside of the lens body can be configured to attenuate visible light in one or more spectral bands. In aspects in which the optical filter comprising the dye of Formula I is within the lens body, the optical filter comprising the dye of Formula I can constitute the lens body, or the optical filter comprising the dye of Formula I and additional components can constitute the lens body.

In some aspects, the optical filter comprising the dye of Formula I is at least partially incorporated into the lens body. For example, and in some aspects, the lens body can be impregnated with, loaded with, or otherwise comprise at least one dye of Formula I, such any of the compounds provide in Table 1, and in particular aspects 5-((3,5-dimethyl-1H-pyrrol-2-yl)methylene)-1-ethyl-4-methyl-2,6-dioxo-1,2,5,6-tetrahydropyridine-3-carbonitrile; 5-((1H-pyrrol-2-yl)methylene)-4-methyl-2,6-dioxo-1,2,5,6-tetrahydropyridine-3-carbonitrile; 5-((1H-pyrrol-2-yl)methylene)-1-ethyl-4-methyl-2,6-dioxo-1,2,5,6-tetrahydropyridine-3-carbonitrile; 5-((3,5-dimethyl-1H-pyrrol-2-yl)methylene)-4-methyl-2,6-dioxo-1,2,5,6-tetrahydropyridine-3-carbonitrile; 4-((1H-pyrrol-2-yl)methylene)isoquinoline-1,3(2H,4H)-dione; and 4-((3,5-dimethyl-1H-pyrrol-2-yl)methylene)isoquinoline-1,3(2H,4H)-dione.

In another aspect, the article comprising the at least one dye of Formula I selectively blocks visible light within a spectral band of wavelengths ranging from about 430 nm to about 470 nm; about 430 nm to about 450 nm; about 450 nm to about 470 nm, or about 440 nm to about 460 nm.

In some aspects, the article comprising the at least one dye of Formula I further comprises one or more secondary dyes.

In one aspect, the present disclosure is directed to a dyed article comprising a polymer material and at least one dye of Formula I. In certain aspects, the polymer material is selected from the group consisting of an acrylic resin, a styrenic resin, a cellulosic resin, a polyamide resin, a polycarbonate resin, a polyester resin, a polyethylene resin, a polyimide resin, and a polyurethane resin.

In some aspects, the polymer material is transparent.

In some aspects the polymer material may be predominantly a single monomer (homopolymer), or co-polymers and blends.

In another aspects, the present disclosure is directed to the dyed article, wherein the polymer material is crosslinked or linear.

In another aspect, the optical filter is at least partially incorporated into a lens coating, an adhering layer, a polarizing layer, a photochromic layer, an anti-reflection layer, other functional layer, or is at least partially incorporated into a combination of coatings and layers.

In some aspects, the optical filter comprising the at least one dye of Formula I further comprises a polymeric material.

In some aspects, the at least one dye of Formula I is at least partially incorporated into the polymeric material.

In some aspects, the article can also include additives, including additives that improve the light stability of the dye or the integrity of the resin, for example UV absorbers. The article can also include additives that improve the mechanical properties of the article, for example, impact modifiers. The article can consist of a single layer, two layers, or three or more layers, each of which can comprise the dyes and additives.

In some aspects, the at least one dye of Formula I is
5-((3,5-dimethyl-1H-pyrrol-2-yl)methylene)-1-ethyl-4-methyl-2,6-dioxo-1,2,5,6-tetrahydropyridine-3-carbonitrile;
5-((1H-pyrrol-2-yl)methylene)-4-methyl-2,6-dioxo-1,2,5,6-tetrahydropyridine-3-carbonitrile;
5-((1H-pyrrol-2-yl)methylene)-1-ethyl-4-methyl-2,6-dioxo-1,2,5,6-tetrahydropyridine-3-carbonitrile;
5-((4-(tert-butyl)-1H-pyrrol-2-yl)methylene)-1-ethyl-4-methyl-2,6-dioxo-1,2,5,6-tetrahydropyridine-3-carbonitrile;
5-((4-(tert-butyl)-1H-pyrrol-2-yl)methylene)-4-methyl-2,6-dioxo-1,2,5,6-tetrahydropyridine-3-carbonitrile;
5-((3,5-dimethyl-1H-pyrrol-2-yl)methylene)-4-methyl-2,6-dioxo-1,2,5,6-tetrahydropyridine-3-carbonitrile;
4-((1H-pyrrol-2-yl)methylene)isoquinoline-1,3(2H,4H)-dione;
4-((4-(tert-butyl)-1H-pyrrol-2-yl)methylene)isoquinoline-1,3(2H,4H)-dione; and
4-((3,5-dimethyl-1H-pyrrol-2-yl)methylene)isoquinoline-1,3(2H,4H)-dione.

In some aspects, the at least one dye of Formula I is (E)-5-((1H-pyrrol-2-yl)methylene)-4-methyl-2,6-dioxo-1,2,5,6-tetrahydropyridine-3-carbonitrile, (Z)-5-((1H-pyrrol-2-yl)methylene)-4-methyl-2,6-dioxo-1,2,5,6-tetrahydropyridine-3-carbonitrile, or a combination thereof.

In some aspects, the at least one dye of Formula I is (E)-5-((1H-pyrrol-2-yl)methylene)-1-ethyl-4-methyl-2,6-dioxo-1,2,5,6-tetrahydropyridine-3-carbonitrile, (Z)-5-((1H-pyrrol-2-yl)methylene)-1-ethyl-4-methyl-2,6-dioxo-1,2,5,6-tetrahydropyridine-3-carbonitrile, or a combination thereof.

In some aspects, the at least one dye of Formula I is (E)-1-ethyl-4-methyl-5-((1-methyl-1H-pyrrol-2-yl)methylene)-2,6-dioxo-1,2,5,6-tetrahydropyridine-3-carbonitrile, (Z)-1-ethyl-4-methyl-5-((1-methyl-1H-pyrrol-2-yl)methylene)-2,6-dioxo-1,2,5,6-tetrahydropyridine-3-carbonitrile, or a combination thereof.

In some aspects, the at least one dye of Formula I is (E)-4-((1H-pyrrol-2-yl)methylene)isoquinoline-1,3(2H,4H)-dione, (Z)-4-((1H-pyrrol-2-yl)methylene)isoquinoline-1,3(2H,4H)-dione, or a combination thereof.

In certain aspects, the visible light absorbing articles described herein have an optical density (OD) greater than or equal to about 6.0 from a wavelength range of about 430 nm to about 470 nm. The article provides protection from blue and violet light and has a steep transition in transmission near 500 nm yielding an internal transmission of about 90% calculated using Illuminant C per the methods described in ANSI standard Z80.3 and related documents. The present disclosure also provides visible light absorbing articles with an optical density (OD) less than about 6.0 from a wavelength range of about 430 nm to about 470 nm. Desired optical performance at both higher or lower optical densities can be achieved through the use of higher and lower concentrations of compound of the dye or dyes of Formula I, or through the use of thicker or thinner article cross-sections, or a combination thereof. The dyes of Formula I unexpectedly provided articles with simultaneously high optical density at violet and blue visible wavelengths and high average visual light transmission. Further, the OD of the article comprising one or more dyes of Formula I at wavelengths less than about 430 nm can be supplemented with other blue, violet, and ultraviolet absorbing dyes with almost no effect on the overall visual light transmission.

In some aspects, the article comprising the dye of Formula I has an optical density (OD) of between about 2 and about 12 OD; about 3 and about 11 OD; about 4 and about 10 OD; about 5 and about 9 OD; about 6 and about 8 OD; about 2 and about 6 OD; or about 6 and about 12 OD.

In some aspects, the article comprising the at least one dye of Formula I has an optical density (OD) of about 2, about 3, about 4, about 5, about 6, about 7, about 8, about 9, about 10, about 11, or about 12.

In some aspects, the article comprising the at least one dye of Formula I has an internal visual luminous transmission of no more than about 94%, no more than about 93%, no more than about 92%, no more than about 91%, no more than about 90%, no more than about 89%, no more than about 88%, no more than about 87%, no more than about 86%, no more than about 86%, or no more than 85%.

FIG. 1 illustrates a perspective view of articles 102 a, 102 b that comprise the optical filter comprising a dye of Formula I, according to some aspects. Eyewear 100 includes the pair of lenses 102 a, 102 band can be of any type, including general-purpose eyewear, protective eyewear, special-purpose eyewear, sunglasses, face-shields (including eye-shields), eyewear incorporated into headworn support (such as visors for helmets), visors, driving glasses, sporting glasses, goggles, vision-correcting eyewear, prescription and non-prescription eyeglasses, color vision deficiency eyewear, indoor eyewear, outdoor eyewear, contrast-enhancing eyewear, chroma-enhancing eyewear, color-enhancing eyewear, color-altering eyewear, gaming eyewear, eyewear designed for another purpose, or eyewear designed for a combination of purposes. In some aspects, lenses and frames of many other shapes and configurations may be used for eyewear 100. For example, eyewear 100 can have a single, unitary lens, such as in a goggle or visor and such lens comprise the optical filter comprising a dye of Formula I and at least one minus violet dye. It should be noted that eyewear 100 shown in FIG. 1 is not drawn to scale but is drawn to more easily illustrate certain aspects of eyewear 100.

In some aspects, a lens can comprise a lens body and an optical filter comprising at least one dye of Formula I.

In another embodiment, the optical filter can be the lens body. In another embodiment, the optical filter can be partially incorporated into the lens body.

In some aspects, the at least one dye of Formula I can be present in the article in a range of about 0.0002% to about 6%; about 0.002% to about 6%; about 0.02% to about 6%; about 0.2% to about 6%; about 0.0002% to about 5%; about 0.2% to about 4%; about 0.2% to about 3%; or about 0.2% to about 2% by weight.

In some aspects, the at least one dye of Formula I and one or more secondary dyes can be present in the article in a range of about 0.0002% to about 6%; about 0.002% to about 6%; about 0.02% to about 6%; about 0.2% to about 6%; about 0.0002% to about 5%; about 0.2% to about 4%; about 0.2% to about 3%; or about 0.2% to about 2% by weight.

Weight percent is calculated based on [i] the total weight of a particular dye incorporated into the lens relative to [ii] the total weight of the lens.

In some aspects, the article comprising the dye of Formula I has a thickness from about 0.05 mm to about 40 mm; from about 0.05 to about 20 mm; from about 0.05 to about 10 mm; from about 0.05 to about 5 mm; from about 0.05 mm to about 1 mm; from about 0.1 to about 15 mm; from about 1 mm to about 10 mm; from about 2 mm to about 8 mm; from about 3 mm to about 6 mm; from about 10 mm to about 40 mm; from about 15 mm to about 40 mm; from about 20 mm to about 40 mm; from about 30 mm to about 40 mm; from about 15 mm to about 35 mm; or from about 20 mm to about 30 mm.

In some aspects, the article comprising the dye of Formula I and one or more secondary dyes has a thickness from about 0.05 mm to about 40 mm; from about 0.05 to about 20 mm; from about 0.05 to about 10 mm; from about 0.05 to about 5 mm; from about 0.05 mm to about 1 mm; from about 0.1 to about 15 mm; from about 1 mm to about 10 mm; from about 2 mm to about 8 mm; from about 3 mm to about 6 mm; from about 10 mm to about 40 mm; from about 15 mm to about 40 mm; from about 20 mm to about 40 mm; from about 30 mm to about 40 mm; from about 15 mm to about 35 mm; or from about 20 mm to about 30 mm.

Lenses 102 a, 102 b can be implemented in any headworn support (i.e., a headworn article that can support one or more lenses in the wearer's field of view). For example, other headworn supports can include, but are not limited to, helmets, face masks, balaclavas, and breaching shields. The lenses 102 a and 102 b can be corrective lenses or non-corrective lenses and can be made of any of a variety of optical materials including glass and/or plastics, such as, for example, acrylics or polycarbonates. The lenses can have various shapes. For example, the lenses 102 a, 102 b can be flat, have 1 axis of curvature, 2 axes of curvature, or more than 2 axes of curvature, the lenses 102 a, 102 b can be cylindrical, parabolic, spherical, flat, or elliptical, or any other shape such as a meniscus or catenoid. When worn, the lenses 102 a, 102 b can extend across the wearer's normal straight ahead line of sight, and can extend substantially across the wearer's peripheral zones of vision. As used herein, the wearer's normal line of sight shall refer to a line projecting straight ahead of the wearer's eye, with substantially no angular deviation in either the vertical or horizontal planes. In some aspects, the lenses 102 a, 102 b extend across a portion of the wearer's normal straight ahead line of sight.

The outside surface of lenses 102 a or 102 b can conform to a shape having a smooth, continuous surface having a constant horizontal radius (sphere or cylinder) or progressive curve (ellipse, toroid or ovoid) or other aspheric shape in either the horizontal or vertical planes. The geometric shape of other aspects can be generally cylindrical, having curvature in one axis and no curvature in a second axis. The lenses 102 a, 102 b can have a curvature in one or more dimensions. For example, the lenses 102 a, 102 b can be curved along a horizontal axis. As another example, lenses 102 a, 102 b can be characterized in a horizontal plane by a generally arcuate shape, extending from a medial edge throughout at least a portion of the wearer's range of vision to a lateral edge. In some aspects, the lenses 102 a, 102 b are substantially linear (not curved) along a vertical axis. In some aspects, the lenses 102 a, 102 b have a first radius of curvature in one region, a second radius of curvature in a second region, and transition sites disposed on either side of the first and second regions. The transition sites can be a coincidence point along the lenses 102 a, 102 b where the radius of curvature of the lenses 102 a, 102 b transitions from the first to the second radius of curvature, and vice versa. In some aspects, lenses 102 a, 102 b can have a third radius of curvature in a parallel direction, a perpendicular direction, or some other direction. In some aspects, the lenses 102 a, 102 b can lie on a common circle. The right and left lenses in a high-wrap eyeglass can be canted such that the medial edge of each lens will fall outside of the common circle and the lateral edges will fall inside of the common circle. Providing curvature in the lenses 102 a, 102 b can result in various advantageous optical qualities for the wearer, including reducing the prismatic shift of light rays passing through the lenses 102 a, 102 b, and providing an optical correction.

A variety of lens configurations in both horizontal and vertical planes are possible. Thus, for example, either the outer or the inner or both surfaces of the lens 102 a or 102 b of some aspects can generally conform to a spherical shape or to a right circular cylinder. Alternatively either the outer or the inner or both surfaces of the lens can conform to a frustoconical shape, a toroid, an elliptic cylinder, an ellipsoid, an ellipsoid of revolution, other asphere or any of a number of other three dimensional shapes. Regardless of the particular vertical or horizontal curvature of one surface, however, the other surface can be chosen such as to minimize one or more of power, prism, and astigmatism of the lens in the mounted and as-worn orientation.

The lenses 102 a, 102 b can be linear (not curved) along a vertical plane (e.g., cylindrical or frustoconical lens geometry). In some aspects, the lenses 102 a, 102 b can be aligned substantially parallel with the vertical axis such that the line of sight is substantially normal to the anterior surface and the posterior surface of the lenses 102 a, 102 b. In some aspects, the lenses 102 a, 102 b are angled downward such that a line normal to the lens is offset from the straight ahead normal line of sight by an angle Φ. The angle Φ of offset can be greater than about 0° and/or less than about 30°, or greater than about 70° and/or less than about 20°, or about 15°, although other angles Φ outside of these ranges can also be used. Various cylindrically shaped lenses can be used. The anterior surface and/or the posterior surface of the lenses 102 a, 102 b can conform to the surface of a right circular cylinder such that the radius of curvature along the horizontal axis is substantially uniform. An elliptical cylinder can be used to provide lenses that have non-uniform curvature in the horizontal direction. For example, a lens can be more curved near its lateral edge than its medial edge. In some aspects, an oblique (non-right) cylinder can be used, for example, to provide a lens that is angled in the vertical direction.

In some aspects, the eyewear 100 incorporates canted lenses 102 a, 102 b mounted in a position rotated laterally relative to conventional centrally oriented dual lens mountings. A canted lens can be conceived as having an orientation, relative to the wearer's head, which would be achieved by starting with conventional dual lens eyewear having centrally oriented lenses and bending the frame inwardly at the temples to wrap around the side of the head. When the eyewear 100 is worn, a lateral edge of the lens wraps significantly around and comes in close proximity to the wearer's temple to provide significant lateral eye coverage.

A degree of wrap may be desirable for aesthetic styling reasons, for lateral protection of the eyes from flying debris, or for interception of peripheral light. Wrap can be attained by utilizing lenses of tight horizontal curvature (high base), such as cylindrical or spherical lenses, and/or by mounting each lens in a position which is canted laterally and rearwardly relative to centrally oriented dual lenses. Similarly, a high degree of rake or vertical tilting may be desirable for aesthetic reasons and for intercepting light, wind, dust or other debris from below the wearer's eyes. In general, “rake” will be understood to describe the condition of a lens, in the as-worn orientation, for which the normal line of sight strikes a vertical tangent to the lens 102 a or 102 b at a non-perpendicular angle.

The lenses 102 a, 102 b can be provided with anterior and posterior surfaces and a thickness therebetween, which can be variable along the horizontal direction, vertical direction, or combination of directions. In some aspects, the lenses 102 a, 102 b can have a varying thickness along the horizontal or vertical axis, or along some other direction. In some aspects, the thickness of the lenses 102 a, 102 b tapers smoothly, though not necessarily linearly, from a maximum thickness proximate a medial edge to a relatively lesser thickness at a lateral edge. The lenses 102 a, 102 b can have a tapering thickness along the horizontal axis and can be decentered for optical correction. In some aspects, the lenses 102 a, 102 b can have a thickness configured to provide an optical correction. For example, the thickness of the lenses 102 a, 102 b can taper from a thickest point at a central point of the lenses 102 a, 102 b approaching lateral segments of the lenses 102 a, 102 b. In some aspects, the average thickness of the lenses 102 a, 102 b in the lateral segments can be less than the average thickness of the lenses 102 a, 102 b in the central zone. In some aspects, the thickness of the lenses 102 a, 102 b in at least one point in the central zone can be greater than the thickness of the lenses 102 a, 102 b at any point within at least one of the lateral segments.

In some aspects, the lenses 102 a, 102 b can be finished, as opposed to semi-finished, with the lenses 102 a, 102 b being contoured to modify the focal power. In some aspects, the lenses 102 a, 102 b can be semi-finished so that the lenses 102 a, 102 b can be capable of being machined, at some time following manufacture, to modify their focal power. In some aspects, the lenses 102 a, 102 b can have optical power and can be prescription lenses configured to correct for near-sighted or far-sighted vision. The lenses 102 a, 102 b can have cylindrical characteristics to correct for astigmatism.

The eyewear 100 can include a mounting frame 104 configured to support the lenses 102 a, 102 b. The mounting frame 104 can include orbitals that partially or completely surround the lenses 102 a, 102 b. Referring to FIG. 1, it should be noted that the particular mounting frame 104 is not essential to the aspect disclosed herein. The frame 104 can be of varying configurations and designs, and the illustrated aspect shown in FIG. 1 is provided as examples only. As illustrated, the frame 104 can include a top frame portion and a pair of ear stems 106 a, 106 b that are connected to opposing ends of the top frame portion. Further, the lenses 102 a, 102 b can be mounted to the frame 104 with an upper edge of the lens 102 a or 102 b extending along or within a lens groove and being secured to the frame 104. For example, the upper edge of the lens 102 a or 102 b can be formed in a pattern, such as a jagged or non-linear edge, and apertures or other shapes around which the frame 104 can be injection molded or fastened in order to secure the lens 102 a or 102 b to the frame 104. Further, the lenses 102 a, 102 b can be removably attachable to the frame 104 by means of a slot with inter-fitting projections or other attachment structure formed in the lenses 102 a, 102 b and/or the frame 104.

It is also contemplated that the lenses 102 a, 102 b can be secured along a lower edge of the frame 104. Various other configurations can also be utilized. Such configurations can include the direct attachment of the ear stems 106 a, 106 b to the lenses 102 a, 102 b without any frame, or other configurations that can reduce the overall weight, size, or profile of the eyeglasses. In addition, various materials can be utilized in the manufacture of the frame 104, such as metals, composites, or relatively rigid, molded thermoplastic materials which are well known in the art, and which can be transparent or available in a variety of colors. Indeed, the mounting frame 104 can be fabricated according to various configurations and designs as desired. In some aspects, the frame 104 is configured to retain a unitary lens that is placed in front of both eyes when the eyewear is worn. Eyewear (e.g., goggles) can also be provided that include a unitary lens that is placed in front of both eyes when the eyewear is worn. The unitary lens having features similar to the lenses 102 a, 102 b can be implemented in other types of headworn supports such as, but not limited to, helmets, face masks, balaclavas, and breaching shields. The disclosures herein throughout concerning lenses 102 a, 102 b apply likewise to a unitary lens article.

In some aspects, the ear stems 106 a, 106 b can be pivotably attached to the frame 104. In some aspects, the ear stems 106 a, 106 b attach directly to the lenses 102 a, 102 b. The ear stems 106 a, 106 b can be configured to support the eyewear 100 when worn by a user. For example, the ear stems 106 a, 106 b can be configured to rest on the ears of the user. In some aspects, the eyewear 100 includes a flexible band used to secure the eyewear 100 in front of the user's eyes in place of ear stems 106 a, 106 b.

In some aspects of the lenses 102 a and 102 b that includes the optical filter comprising at least one dye of Formula I, can comprise a lens body 108 and a lens component 110, as illustrated in FIG. 1A. The lens body 108 can have an inner surface facing the eye and an outer surface opposite the inner surface. The inner surface and/or the outer surface of the lens body 108 can be curved (e.g., convex or concave). In some aspects, the inner and/or the outer surface of the lens body 108 can be planar. The lens component 110 can be substantially permanently affixed to the lens body 108, or the lens component 110 can be configured to be separable from the lens body 108. The lens component 110 can be attached to the inner or outer surface of the lens body 108. In some aspects, the lens component 110 can be configured to be removable such that a user, manufacturer, or retailer can apply, remove, or change the lens component 110 after manufacture of the eyewear 100. In this way, a variety of functional elements can be introduced into the eyewear 100 increasing the possible utility of the eyewear 100 because the eyewear can be altered to provide functionality suitable for different occasions. In some aspects, the lens component 110 includes a laminate, a coating, a flexible material, an inflexible material, an insert molded component, a chip, a gel layer, a liquid layer, an air gap, a filter, or any combination of components.

The lens body 108 that incorporates the optical filter comprising at least one dye of Formula I can be formed of polymer, polycarbonate (or PC), allyl diglycol carbonate monomer (being sold under the brand name CR-39®), glass, polyamide, polyurethane, polyethylene, polyimide, polyethylene terephthalate (or PET), biaxially-oriented polyethylene terephthalate polyester film (or BoPET, with one such polyester film sold under the brand name MYLAR®), acrylic (polymethyl methacrylate or PMMA), a polymeric material, a co-polymer, a doped material, any other suitable material, or any combination of materials.

The lens body 108 can be rigid and other layers of the lens can conform to the shape of the lens body 108 such that the lens body 108 dictates the shape of the lens 102 a or 102 b. The lens body 108 can be symmetrical across a vertical axis of symmetry, symmetrical across a horizontal axis of symmetry, symmetrical across another axis, or asymmetrical. In some aspects, the front and back surfaces of the lens body 108 can conform to the surfaces of respective cylinders that have a common center point and different radii. In some aspects, the lens body can have a front and back surfaces that conform to the surfaces of respective cylinders that have center points offset from each other, such that the thickness of the lens body 108 tapers from a thicker central portion to thinner end portions. The surfaces of the lens body 108 can conform to other shapes, as discussed herein, such as a sphere, toroid, ellipsoid, asphere, plano, frustoconical, and the like. In some aspects, a thermoforming process, a molding process, a casting process, a lamination process, an extrusion process, an adhering process, and/or another suitable process can be used to attach the lens component 110 to the lens body 108 having a shape described herein.

The lens body 108 can be contoured during initial formation to have an optical magnification characteristic that modifies the focal power of the lens 102 a or 102 b. In some aspects, the lens body 108 can be machined after initial formation to modify the focal power of the lens 102 a or 102 b. The lens body 108 can provide a substantial amount of the optical power and magnification characteristics to the lens 102 a or 102 b. In some aspects, the lens body 108 provides the majority of the optical power and magnification characteristics. Apportioning the majority of optical power and magnification to the lens body 108 can permit selection of lens body 108 materials and lens body 108 formation techniques that provide improved lens 102 a, 102 b optical power and magnification characteristics, without adversely affecting selection of lens component 110 materials and formation techniques.

In some aspects, the lens body 108 can be injection molded, although other processes can be used to form the shape of the lens blank body, such as thermoforming, casting, extruding, slumping, or machining. In some aspects, the lens body 108 is injection molded and includes a relatively rigid and optically acceptable material such as polycarbonate. The curvature of the lens body 108 would thus be incorporated into a molded lens blank. A lens blank can include the desired curvature and taper in its as-molded condition. One or two or more lens bodies of the desired shape can then be cut from the optically appropriate portion of the lens blank as is understood in the art. In some aspects, the frame 104 is provided with a slot or other attachment structure that cooperates with the molded and cut shape of the lens body 108 and lens component 110 to minimize deviation from, and even improve retention of its intended shape. In some aspects, the lens body 108 can be stamped or cut from flat sheet stock and then bent into the curved configuration using a process such as thermoforming. This curved configuration can then be maintained by the use of a relatively rigid, curved frame 104, or by heating the curved sheet to retain its curved configuration.

The lens component 110 can be attached to the lens body 108, for example, through a thermally-cured adhesive layer, a UV-cured adhesive layer, electrostatic adhesion, pressure sensitive adhesives, or any combination of these. Examples of bonding technologies that can be suitable for attaching the lens component 110 to the lens body 108 include thermal welding, fusing, pressure sensitive adhesives, polyurethane adhesives, electrostatic attraction, thermoforming, other types of adhesives, materials curable by ultraviolet light, thermally curable materials, radiation-curable materials, other bonding methods, other bonding materials, and combinations of methods and/or materials. In some aspects, any technique suitable for affixing the lens component 110 to the lens body 108 can be used. Some aspects of a lens 102 a or 102 b includes a lens body 108 and a lens component 110 that are bonded together. In some aspects, the lens component 110 and the lens body 108 can be integrally connected to each other and can be adhesively bonded together.

The lens component 110 can include a single layer or multiple layers. The lens component 110 can have one or more layers in single or multiple layer form that can be coated with a hard coat or a primer. For example, the lens component 110 can be a single layer of polycarbonate, polyester, PET, polyethylene, acrylic, polyamide, polyurethane, polyimide, BoPET, styrenic, cellulosic, another film material, or a combination of materials. As another example, the lens component can include multiple layers of film, where each film layer includes polycarbonate, polyester, PET, polyethylene, acrylic, polyamide, polyurethane, polyimide, BoPET, styrenic, cellulosic, another film material, or a combination of materials.

Each of the lens component 110 and/or lens body 108 can include one or more layers that serve various functions within the lenses 102 a, 102 b. In some aspects, one or more layers in the lens component 110 and/or the lens body 108 can provide optical properties to the lenses 102 a, 102 b such as optical filtering, polarization, photochromism, electrochromism, photoelectrochromism and/or partial reflection of incoming visible light, chroma enhancement, color enhancement, color alteration, or any combination of these. In some aspects, one or more layers within the lens component 110 and/or the lens body 108 can provide mechanical protection to the lenses 102 a, 102 b or other layers within the lens component 110, reduce stresses within the lens component 110, or improve bonding or adhesion among the layers in the lens component 110 and/or between the lens component 110 and the lens body 108. In some aspects, the lens component 110 and/or the lens body 108 can include layers that provide additional functionality to the lenses 102 a, 102 b such as, for example, anti-reflection functionality, anti-static functionality, anti-fog functionality, scratch resistance, mechanical durability, hydrophobic functionality, reflective functionality, darkening functionality, aesthetic functionality including tinting, or any combination of these.

Accordingly some aspects of the lens body 108 and/or lens component 110 can include a polarizing layer configured to provide polarization, one or more adhesive layers, a photochromic layer, an electrochromic layer configured to provide electrochromism, a photoelectrochomic layer, reflective layer configured to provide a partial reflection of incoming visible light, a hard coat, a flash mirror, a liquid-containing layer, an antireflection layer, a mirror layer, an interference stack, chroma enhancing dyes, an index-matching layer, a scratch resistant coating, a hydrophobic coating, an absorption layer configured to provide a partial or complete absorption of infrared light, a color enhancement layer, a color alteration layer, an anti-static coating, an anti-fog functional layer, chroma enhancement dyes, color enhancement elements, a darkening functional layer, an aesthetic functional layer including tinting, laser attenuation filters, trichoic filters, violet edge filter, UV filter, IR filter, glass layers, hybrid glass-plastic layers, anti-reflective coatings, contrast enhancement elements, a liquid-containing layer, a gel containing layer, a refractive index matching layer, thermal insulation layer, electrical insulation layer, electrical conducting layer, neutral density filter, other lens elements, or a combination of lens components. In some aspects, the optical filter comprising the dye of Formula I is at least partially incorporated into a lens body and/or lens component or one or more functional layers. In some aspects, the optical filter comprising the dye of Formula I is at least partially incorporated into lens body 108 and/or lens component 110 or one or more functional layers (e.g. a lens coating, an adhering layer, a polarizing layer, a photochromic layer, an anti-reflection layer, or is at least partially incorporated into a combination of coatings and layers). In some aspects, the process of forming the lens body can include forming a protective wafer, and forming a lens substrate over the protective wafer. By way of example and not limitation, the process of forming a protective wafer can include injection molding or casting a wafer that includes one or more wavelength filtering materials. By way of example and not limitation, the process of forming the lens body over the wavelength protective wafer can include placing the protective wafer in a mold cavity and molding an optically transparent material, such as resin, over one or more surfaces of the wavelength filtering wafer in the mold cavity. As a result, after the optically transparent material (e.g., resin) is cooled down and hardened, the lens body can conform to the wavelength filtering wafer. It is noted that the above described embodiments for forming the lens body are exemplary and not limiting. Various implementations for forming the lens body are described, for example, in U.S. Patent Publication. No. 2017/0075143, which is incorporated by reference herein in its entirety.

As an example, the lens component 110 can include one or more layers that can serve to thermally insulate the lens component 110 such that it can be used in high temperature molding processes without subjecting the certain functional layers to temperatures sufficient to significantly degrade their optical performance. In some aspects, the lens component 110 can serve as a thermally isolating element or vehicle that can incorporate functional elements that can be degraded if subjected to high temperature manufacturing processes. As such, the lens component 110 can be used to incorporate these types of functional elements into lenses that otherwise are formed and/or manufactured using high temperature processes. As another example, the lens component 110 can include a substrate with one or more functional coatings deposited thereon. The functional coatings can include elements that would be degraded or whose performance would be altered if subjected to high temperatures, such as certain protective dyes. The lens component 110 could then be bonded to the lens body 108 using a UV-cured adhesive, thus thermally isolating the lens component 110 and the included functional layers from the high temperature processes associated with the manufacture of the lens body 108.

In certain aspects, lens 102 a or 102 b that includes the optical filter comprising at least one dye of Formula I can also incorporate additional functionality. The lens component 110 or the lens body 108 can include layers or elements that serve to tint the lens 102 a, 102 b. Tinting can be added to a lens element in different ways. In some aspects, color can be deposited on the lens element using a vapor or liquid source. The color can coat the lens element or it can penetrate into the element, and/or can be applied using a sublimation process. In some aspects, color can be added to a material used to make the lens element, such as adding powdered color or plastic pellets to material that is extruded, injection molded, or otherwise molded into a lens element. In some aspects where liquids are used, the color can be added by a dip process. In such aspects, a gradient tint or bi-gradient tint can be achieved through the dip process. In certain aspects, a liquid coloring technique can be used to tint one or more lens elements. For example, liquid dye can be added to the polymer during an injection molding process.

In some aspects, the lens 102 can comprise an optical filter system comprising an optical filter comprising at least one dye of Formula I with variable optical characteristics (also referred to as a variable optical filter) including a variable filter component 114 and an optical filter with fixed optical characteristics (also referred to as a static filter) including a static filter component 116, as illustrated in FIG. 1B and as described in U.S. Pat. No. 10,073,282.

In some aspects, the method of manufacturing a lens can include forming a lens having an optical filter comprising at least one dye of Formula I configured to attenuate visible light in a plurality of spectral bands. Each of the plurality of spectral bands can include an absorbance peak with a spectral bandwidth, a maximum absorbance, and an integrated absorptance peak area within the spectral bandwidth. An attenuation factor of the absorbance peak in each of the plurality of spectral bands can be greater than or equal to about 0.8 and less than 1. In some aspects, a lens can be formed by forming a lens body and forming a lens coating over the lens body. At least a portion of the optical filter can be incorporated into the lens body or the lens coating. In some aspects, the lens coating can include an interference coating. In some aspects, the lens can include a UV absorption layer or a layer that includes UV absorption outside of the optical filter layer. Such a layer can decrease bleaching of the optical filter. In addition, UV absorbing agents can be disposed in any lens component or combination of lens components. In some aspects, a lens body can be formed by a method including forming a plurality of lens body elements and coupling the lens body elements to one another using one or more adhering layers. A polarizing film can be disposed between two or more of the plurality of lens body elements. In some aspects, the polarizing film can be insert molded within the lens body. In some aspects, the lens can include one or more components that substantially absorb ultraviolet radiation, including near ultraviolet radiation. As described in U.S. Patent Publication No. 2022/0107511.

In certain aspects, the dye of Formula I can be added to a molten resin before the resin is injected into a mold cavity to form the lens body. By way of example and not limitation, the optically transparent material can include molten resin, polycarbonate (PC), allyl diglycol carbonate monomer (being sold under the brand name CR-39®), a resin layer (e.g., MR-8®), glass, polyamide, polyurethane, polyethylene, polyureas, polyamide (PA), polyethylene terephthalate (PET), biaxially-oriented polyethylene terephthalate polyester film (BoPET, with one such polyester film sold under the brand name MYLAR®), acrylic (polymethyl methacrylate or PMMA), triacetate cellulose (TAC), a polymeric material, a co-polymer, a doped material, any other suitable material, or any combination thereof as described in U.S. Patent Publication No. 2021/0157170 which is incorporated by reference herein in its entirety.

In some aspects, the process of forming the lens body can include forming a lens substrate, and forming a protective layer over the lens substrate. By way of example and not limitation, a forming process of the lens substrate can include applying an injection molding process, a thermoforming process, a casting process, or a machining process on the optically transparent material described above, as described in U.S. Patent Publication No. 2021/0157170.

### EXAMPLES

The examples presented below are provided for the purpose of illustration only and the aspects described herein should in no way be construed as being limited to these examples. Rather, the aspects should be construed to encompass any and all variations which become evident as a result of the teaching provided herein.

### Example 1: General Procedures

### General Synthesis of Compounds of Formula III

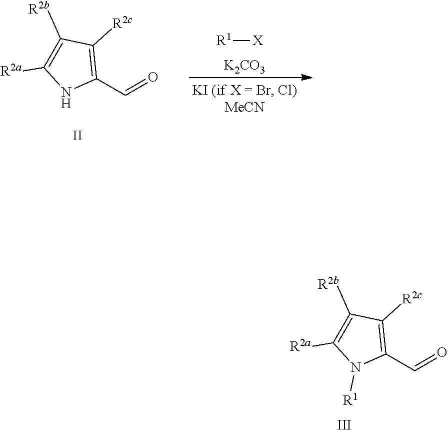

Pyrrole-substituted aldehyde derivatives of Formula II including 2-formylpyrrole, 4-(tert-Butyl)-1H-pyrrole-2-carbaldehyde, 3,5-dimethyl-1H-pyrrole-2-carbaldehyde, ethyl 5-formyl-2,4-dimethyl-1H-pyrrole-3-carboxylate, 5-formyl-2,4-dimethyl-1H-pyrrole-3-carboxylic acid, ethyl 5-formyl-1H-pyrrole-2-carboxylate, and N-(2-(diethylamino) ethyl)-5-formyl-2,4-dimethyl-1H-pyrrole-3-carboxamide were purchased from commercial sources such as Ambeed, Sigma-Aldrich, and TCI.

Procedure A: 2-formylpyrrole derivative (Formula II) (1 equiv), dry MeCN (0.3 M), oven-dried K₂CO₃ (3 equiv), alkyl halide (1.2 to 4.0 equiv), and KI (0.5 equiv if electrophile was alkyl bromide or chloride) were added to a round-bottom flask. The reaction mixture was refluxed and stirred with vigorous stirring. The reaction was monitored by TLC and ¹H NMR. Upon completion, the reaction was cooled to room temperature. The reaction was then diluted with EtOAc and H₂O and the product extracted with EtOAc (3×). The organic layers were combined, dried with MgSO₄, filtered, and concentrated by rotary evaporation. In some cases, the product could be precipitated from EtOH/hexanes and isolated via vacuum filtration. In most cases, the product was filtered through a silica plug, washing initially with hexanes to remove low polarity impurities before eluting product with CH₂Cl₂ or EtOAc. Characterization of representative compounds of Formula III are reported in Table 2.

TABLE 2
Representative compounds of Formula III prepared using Procedure A.

| Ex- | | | |
|---|---|---|---|
| ample | Chemical name | Structure | Comments |
| 22 | 1-methyl-1H-pyrrole-2- carbaldehyde | 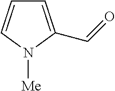 | Isolated 270 mg (84% yield) using iodomethane as the alkyl halide. ¹H NMR (CDCl₃): 9.55 (s, 1H), 6.92 (dd, 1H), 6.88 (br s, 1H), 6.21 (dd, 1H), 3.96 (s, 3H). |
| 23 | 4-(tert-butyl)-1-butyl- 1H-pyrrole-2- carbaldehyde | 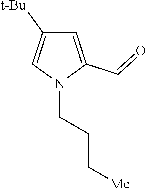 [SMILES: CCCCn1cc(C(C)(C)C)cc1C=O] | Isolated 231 mg (84% yield) using iodobutane as the alkyl halide. ¹H NMR (CDCl₃): 9.46 (s, 1H), 6.80 (s, 1H), 6.78 (s, 1H), 4.24 (t, 2H), 1.72 (quint, 2H), 1.33 (quint, 2H), 1.25 (s, 9H), 0.93 (t, 3H). |
| 24 | 4-(tert-butyl)-1-(4,4,4- trifluorobutyl)-1H- pyrrole-2-carbaldehyde | 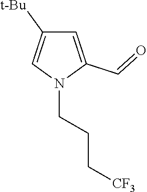 [SMILES: CC(C)(C)c1cc(C=O)n(CCCC(F)(F)F)c1] | Isolated 142 mg (67% yield) using 1-iodo-4,4,4-trifluorobutane as the alkyl halide. ¹H NMR (CDCl₃): 9.46 (s, 1H) 6.84 (s, 1H), 6.77 (s, 1H), 4.33 (t, 2H), 1.98-2.15 (m, 4H), 1.25 (s, 9H). |
| 25 | 4-(tert-butyl)-1- (naphthalen-2- ylmethyl)-1H-pyrrole- 2-carbaldehyde | 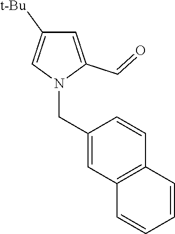 [SMILES: CC(C)(C)c1cc(C=O)n(Cc2ccc3ccccc3c2)c1] | Isolated 82 mg (31% yield) using 2- (Chloromethyl)naphthalene as the alkyl halide. ¹H NMR (CDCl₃): 9.53 (s, 1H), 7.75-7.85 (m, 3H), 7.58 (s, 1H), 7.43-7.51 (m, 2H), 7.30 (d, 1H), 6.89 (s, 1H), 6.86 (s, 1H), 5.68 (s, 2H), 1.25 (s, 9H). |
| 26 | ethyl 2-(4-(tert-butyl)- 2-formyl-1H-pyrrol-1- yl)acetate | 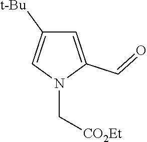 [SMILES: CCOC(=O)Cn1cc(C(C)(C)C)cc1C=O] | Isolated 389 mg (87% yield) using ethyl bromoacetate as the alkyl halide. ¹H NMR (CDCl₃): 9.46 (s, 1H), 6.87 (s, 1H), 6.74 (s, 1H), 4.99 (s, 2H), 4.15-4.30 (m, 2H), 1.28-1.32 (m, 3H), 1.26 (s, 9H). |
| 27 | 2-(4-(tert-butyl)-2- formyl-1H-pyrrol-1- yl)acetonitrile | 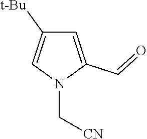 [SMILES: CC(C)(C)c1cc(C=O)n(CC#N)c1] | Isolated 72 mg (29% yield) using bromoacetonitrile as the alkyl halide. ¹H NMR (CDCl₃): 9.52 (s, 1H), 6.87-6.92 (m, 2H), 5.33 (s, 2H), 1.26 (s, 9H). |
| 28 | ethyl 1-(cyanomethyl)- 5-formyl-2,4-dimethyl- 1H-pyrrole-3- carboxylate | 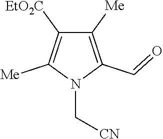 [SMILES: CCOC(=O)c1c(C)c(C=O)n(CC#N)c1C] | Isolated 125 mg (75% yield) via bromoacetonitrile as the alkyl halide. ¹H NMR (CDCl₃): 9.77 (s, 1H), 5.48 (s, 2H), 4.33 (quart, 2H), 2.65 (s, 3H), 2.54 (s, 3H), 1.38 (t, 3H). |

### General Procedure: Synthesis of Compounds of Formula I

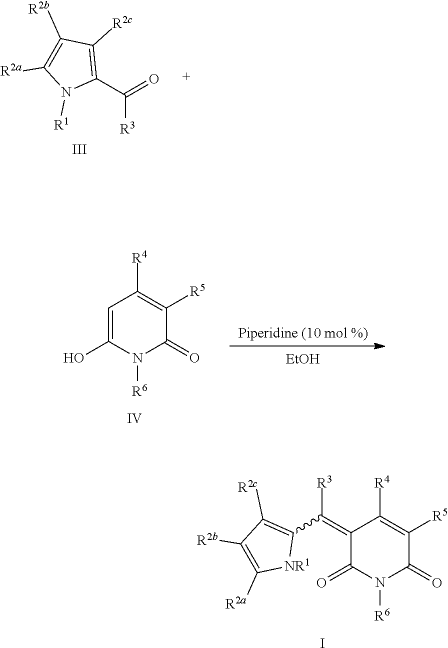

Pyridone and isoquinoline derivatives of Formula IV including 2,6-dihydroxy-4-methylnicotinonitrile, 1-ethyl-6-hydroxy-4-methyl-2-oxo-1,2-dihydropyridine-3-carbonitrile, and 3-hydroxyisoquinolin-1 (2H)-one were purchased from commercial sources such as TCI, Ambeed, and Oakwood Chemicals.

Procedure B: Pyridine/isoquinoline derivative (Formula IV) (1.0 to 1.2 equiv) was added to a mixture of pyrrole-substituted aldehyde (Formula III) (1.0 equiv) in EtOH (0.5 M). A catalytic amount of piperidine (about 10 mol %) was added to the reaction. The reaction mixture was stirred at temperatures ranging from room temperature to 50° C. The reaction progress was monitored by TLC and UV-vis. Typically, as the reaction progressed, a suspension formed. Upon completion, the compounds of Formula I were typically isolated in high yield via vacuum filtration of the reaction mixture and washing the filter cake with EtOH and hexanes. In some cases, the crude solid was obtained via vacuum filtration, dissolved in CH₂Cl₂, and filtered (through a fritted filter or short celite plug) to remove insoluble impurities. The products were analyzed by UV-vis and ¹H NMR spectroscopy. Characterization data for the representative compounds of Formula I are reported in Table 3.

TABLE 3
Representative compounds of Formula I prepared using General Procedure B.

| Com- | | | | |
|---|---|---|---|---|
| pound | | | ¹H NMR (CDCl₃) | Melting |
| No. | Structure | UV-vis (CH₂Cl₂) | or MS (APCI+) | Point (° C.) |
| 1 | 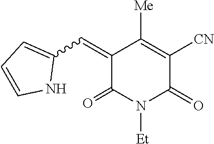 [SMILES: CCN1C(=O)C(=Cc2ccc[nH]2)C(C)=C(C#N)C1=O] | λₘₐₓ = 461.8 nm, FWHM = 49.5 nm, HWHM = 13.0 nm, ε_{g} = 247.7 L · g⁻¹ · cm⁻¹ | ¹H NMR (CDCl₃): 13.46 (br s, 1H), 7.56 (s, 1H), 7.48 (br s, 1H), 7.12 (m, 1H), 6.60 (m, 1H), 4.09 (quart, 2H), 2.62 (s, 3H), 1.24 (t, 3H) | — |
| 2 | 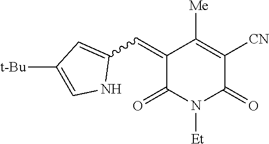 [SMILES: CCN1C(=O)C(=Cc2cc(C(C)(C)C)c[nH]2)C(C)=C(C#N)C1=O] | λₘₐₓ = 473.3 nm, FWHM = 43.4 nm, HWHM = 11.4 nm. | ¹H NMR (CDCl₃): 13.38 (br s, 1H), 7.48 (s, 1H), 7.38 (s, 1H), 6.97 (m, 1H), 4.09 (quart, 2H), 2.60 (s, 3H), 1.31 (s, 9H), 1.24 (t, 3H) | — |
| 3 | 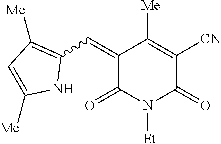 [SMILES: CCN1C(=O)C(=Cc2[nH]c(C)cc2C)C(C)=C(C#N)C1=O] | λₘₐₓ = 480.5 nm, FWHM = 30.6 nm, HWHM = 10.0 nm, ε_{g} = 346.8 L · g⁻¹ · cm⁻¹ | ¹H NMR (CDCl₃): 13.49 (br s, 1H), 7.44 (s, 1H), 6.24 (s, 1H), 4.09 (quart, 2H), 2.60 (s, 3H), 2.48 (s, 3H), 2.37 (s, 3H), 1.24 (t, 3H) | — |
| 4 | 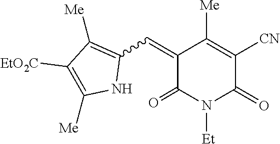 [SMILES: CCOC(=O)c1c(C)[nH]c(C=C2C(=O)N(CC)C(=O)C(C#N)=C2C)c1C] | λₘₐₓ = 479.0 nm, FWHM = 44.5 nm, HWHM = 12.2 nm. | ¹H NMR (CDCl₃): 13.68 (br s, 1H), 7.60 (s, 1H), 4.35 (quart, 2H), 4.09 (quart, 2H), 2.71 (s, 3H), 2.63 (s, 3H), 2.60 (s, 3H), 1.40 (t, 3H), 1.24 (t, 3H) | — |
| 5 | 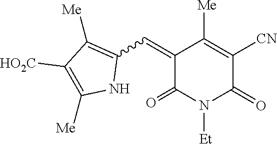 [SMILES: CCN1C(=O)C(=Cc2[nH]c(C)c(C(=O)O)c2C)C(C)=C(C#N)C1=O] | λₘₐₓ = 477.2 nm, FWHM = 47.1 nm, HWHM = 12.6 nm. | ¹H NMR (CDCl₃): 7.66 (s, 1H), 4.12 (m, 2H), 2.77 (s, 3H), 2.68 (s, 3H), 2.66 (s, 3H), 1.29 (m, 3H) | — |
| 6 | 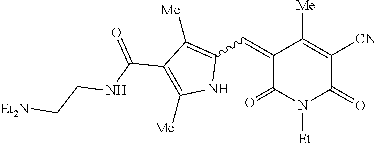 | λₘₐₓ = 484.1 nm, FWHM = 50.0 nm, HWHM = 15.2 nm | — | — |
| 7 | 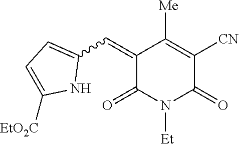 [SMILES: CCOC(=O)c1ccc(C=C2C(=O)N(CC)C(=O)C(C#N)=C2C)[nH]1] | λₘₐₓ = 443.0 nm, FWHM = 66.3 nm, HWHM = 34.0 nm | ¹H NMR (CDCl₃): 13.55 (br s, 1H), 7.53 (s, 1H), 7.05 (m, 1H), 7.00 (m, 1H), 4.45 (quart, 2H), 4.11 (quart, 2H), 2.63 (s, 3H), 1.43 (t, 3H), 1.25 (t, 3H) | — |
| 8 | 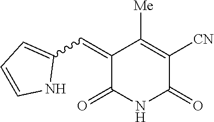 [SMILES: CC1=C(C#N)C(=O)NC(=O)C1=Cc1ccc[nH]1] | λₘₐₓ = 464.2 nm, FWHM = 45.5 nm, HWHM = 11.7 nm | ¹H NMR (CDCl₃): 13.47 (br s, 1H), 8.26 (br s, 1H), 7.60 (s, 1H), 7.53 (m, 1H), 7.16 (m, 1h), 6.63 (m, 1H), 2.65 (s, 3H) | — |
| 9 | 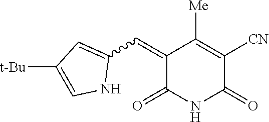 [SMILES: CC1=C(C#N)C(=O)NC(=O)C1=Cc1cc(C(C)(C)C)c[nH]1] | λₘₐₓ = 474.8 nm, FWHM = 39.9 nm, HWHM = 10.6 nm | ¹H NMR (CDCl₃): 13.42 (br s, 1H), 8.34 (br s, 1H), 7.52 (s, 1H), 7.41 (m, 1H), 7.01 (s, 1H), 2.63 (s, 3H), 1.31 (s, 9H) | — |
| 10 | 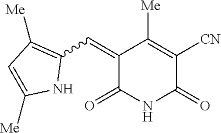 [SMILES: CC1=C(C#N)C(=O)NC(=O)C1=Cc1[nH]c(C)cc1C] | λₘₐₓ = 480.0 nm, FWHM = 28.3 nm, HWHM = 9.5 nm | ¹H NMR (CDCl₃): 13.56 (br s, 1H), 8.29 (br s, 1H), 7.45 (s, 1H), 6.27 (s, 1H), 2.63 (s, 3H), 2.47 (s, 3H), 2.38 (s, 3H) | — |
| 11 | 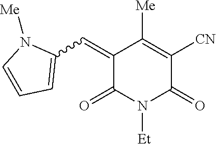 [SMILES: CCN1C(=O)C(=Cc2cccn2C)C(C)=C(C#N)C1=O] | λₘₐₓ = 469.7 nm, FWHM = 59.9 nm, HWHM = 20.2 nm | MS (APCI+): 270.1 m/z | — |
| 12 | 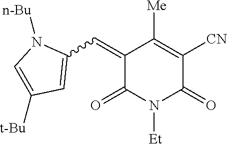 | λₘₐₓ = 481.7 nm, FWHM = 52.8 nm, HWHM = 16.2 nm | ¹H NMR (CDCl₃): 8.47 (s, 1H), 7.50 (s, 1H), 7.20 (s, 1H), 4.01-4.15 (m, 4H), 2.56 (s, 3H), 1.70-1.82 (m, 2H), 1.18-1.40 (m, 14H), 0.96 (t, 3H) MS (APCI+): 368.3 m/z | — |
| 13 | 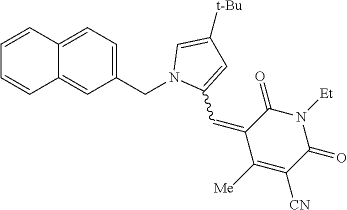 [SMILES: CCN1C(=O)C(=Cc2cc(C(C)(C)C)cn2Cc2ccc3ccccc3c2)C(C)=C(C#N)C1=O] | λₘₐₓ = 480.9 nm, FWHM = 56.2 nm, HWHM = 16.8 nm | — | — |
| 14 | 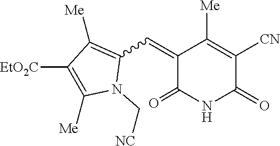 [SMILES: CCOC(=O)c1c(C)c(C=C2C(=O)NC(=O)C(C#N)=C2C)n(CC#N)c1C] | λₘₐₓ = 482.2 nm, FWHM = 77.1 nm, HWHM = 33.8 nm | ¹H NMR (CDCl₃): 7.57 (s, 1H), 4.69 (s, 2H), 3.98 (quart, 2H), 2.78 (s, 3H), 2.63 (s, 3H), 2.38 (s, 3H), 1.18 (t, 3H) | — |
| 15 | 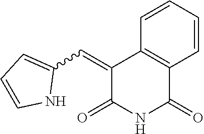 [SMILES: O=C1NC(=O)c2ccccc2C1=Cc1ccc[nH]1] | λₘₐₓ = 427.0 nm, FWHM = 62.2 nm, HWHM = 29.3 nm | ¹H NMR (CDCl₃): 12.99 (br s, 1H), 8.63 (br s, 1H), 8.28 (d, 1H), 7.84- 7.92 (m, 2H), 7.67 (t, 1H), 7.42 (t, 1H), 7.28 (s, 1H), 6.95 (m, 1H), 6.49 (m, 1H) | — |
| 16 | 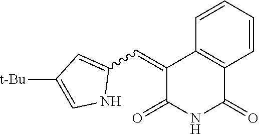 [SMILES: CC(C)(C)c1c[nH]c(C=C2C(=O)NC(=O)c3ccccc32)c1] | λₘₐₓ = 440.4 nm, FWHM = 62.4 nm, HWHM = 28.8 nm | ¹H NMR (CDCl₃): 12.81 (br s, 1H), 8.38 (br s, 1H), 8.27 (d, 1H), 7.86 (d, 1H), 7.83 (s, 1H), 7.66 (t, 1H), 7.40 (t, 1H), 7.14 (m, 1H), 6.85 (m, 1H), 1.31 (s, 9H) | — |
| 17 | 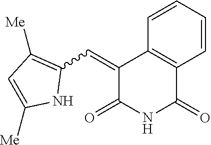 [SMILES: Cc1cc(C)c(C=C2C(=O)NC(=O)c3ccccc32)[nH]1] | UV-vis (CH₂Cl₂): λₘₐₓ = 468.6 nm, FWHM = 56.5 nm, HWHM = 17.0 nm | MS (APCI+): 267.1 m/z | — |
| 18 | 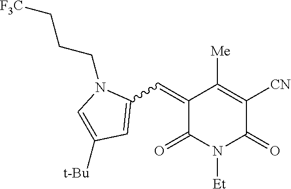 [SMILES: CCN1C(=O)C(=Cc2cc(C(C)(C)C)cn2CCCC(F)(F)F)C(C)=C(C#N)C1=O] | λₘₐₓ = 478.9 nm, FWHM = 57.1 nm, HWHM = 17.3 nm | ¹H NMR (CDCl₃): 8.48 (s, 1H), 7.44 (s, 1H), 7.19 (s, 1H), 4.22 (t, 2H), 4.05 (quart, 2H), 2.56 (s, 3H), 2.00- 2.10 (m, 4H), 1.31 (s, 9H), 1.23 (t, 3H) | — |
| 19 | 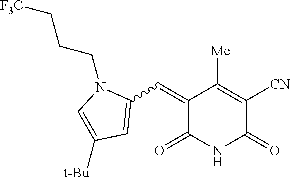 [SMILES: CC1=C(C#N)C(=O)NC(=O)C1=Cc1cc(C(C)(C)C)cn1CCCC(F)(F)F] | λₘₐₓ = 480.6 nm, FWHM = 57.4 nm, HWHM = 17.8 nm | — | — |
| 20 | 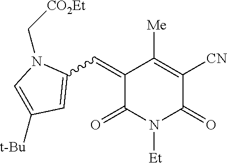 [SMILES: CCOC(=O)Cn1cc(C(C)(C)C)cc1C=C1C(=O)N(CC)C(=O)C(C#N)=C1C] | λₘₐₓ = 477.1 nm, FWHM = 60.3 nm, HWHM = 18.0 nm | ¹H NMR (CDCl₃): 8.53 (s, 1H), 7.37 (s, 1H), 7.16 (s, 1H), 4.82 (s, 2H), 4.27 quart, 2H), 4.06 (quart, 2H), 2.53 (s, 3H), 1.19- 1.35 (m, 15H) | — |
| 21 | 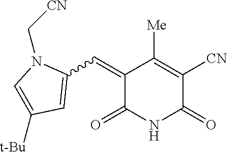 [SMILES: CC1=C(C#N)C(=O)NC(=O)C1=Cc1cc(C(C)(C)C)cn1CC#N] | λₘₐₓ = 474.5 nm, FWHM = 58.7 nm, HWHM = 15.2 nm | — | — |

It is to be appreciated that the Detailed Description section, and not the Summary and Abstract sections, is intended to be used to interpret the claims. The Summary and Abstract sections may set forth one or more but not all exemplary aspects of the present invention as contemplated by the inventor(s), and thus, are not intended to limit the present invention and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific aspects will so fully reveal the general nature of the invention that others can, by applying knowledge within the skill of the art, readily modify and/or adapt for various applications such specific aspects, without undue experimentation, without departing from the general concept of the present invention. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary aspects, but should be defined only in accordance with the following claims and their equivalents.

What is claimed is:

1. A dye of Formula I: 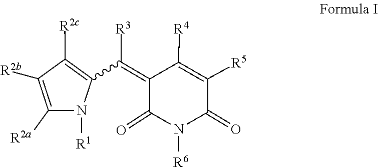
wherein:
R¹ is H, C₁-C₆ alkyl, C₃-C₆ cycloalkyl, C₁-C₆ haloalkyl, (CH₂)ₙCO₂R⁷, (CH₂)ₙC(O)NHR⁷, alkylene-CN, or alkylene-aryl;
R^{2a}, R^{2b}, and R^{2c} are each independently H, halo, C₁-C₆ alkyl, C₃-C₆ cycloalkyl, aryl, alkylene-aryl, (CH₂)ₙCO₂R⁷, or C(O)NHR⁸;
R³ is H, C₁-C₆ alkyl, C₃-C₆ cycloalkyl, C₁-C₆ haloalkyl, aryl, (CH₂)ₙCO₂R⁷, or (CH₂)ₙC(O)NHR⁷;
R⁴ is H, C₁-C₆ alkyl, C₃-C₆ cycloalkyl, C₁-C₆ haloalkyl, aryl, (CH₂)ₙCO₂R⁷, or (CH₂)ₙC(O)NHR⁷ and R⁵ is CN; or R⁴ and R⁵, taken together with the carbons that they are attached to, form an aryl ring;
R⁶ is H, C₁-C₆ alkyl, C₃-C₆ cycloalkyl, C₁-C₆ haloalkyl, aryl, alkylene-CO₂R⁷, alkylene-C(O)NHR⁷, or C₁-C₁₂ alkylene-R¹⁰;
R⁷ is H or C₁-C₆ alkyl;
R⁸ is H, C₁-C₆ alkyl, or (CH₂)ₘ(R⁹)₂;
R⁹ is H or C₁-C₆ alkyl;
R¹⁰ is 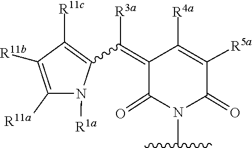
provided that when R⁶ is C₁-C₁₂ alkylene-R¹⁰, R^{1a} is identical to R¹, R^{11a} is identical to R^{2a}, R^{11b} is identical to R^{2b}, R^{11c} is identical to R^{2c}, R^{3a} is identical to R³, R^{4a} is identical to R⁴, and R^{5a} is identical to R⁵;
each n is independently at each occurrence 0, 1, 2, 3, or 4; and
m is 1, 2, 3, or 4.

2. The dye of claim 1, wherein
R¹ is H, C₁-C₆ alkyl, C₁-C₆ haloalkyl, (CH₂)ₘaryl, (CH₂)ₙCO₂R⁷, or (CH₂)ₘCN;
R^{2a}, R^{2b}, and R^{2c} are each independently H, halo, C₁-C₆ alkyl, C₃-C₆ cycloalkyl, aryl, (CH₂)ₙCO₂R⁷, or C(O)NHR⁸;
R³ is H, C₁-C₆ alkyl or C₃-C₆ cycloalkyl;
R⁴ is C₁-C₆ alkyl and R⁵ is CN; or R⁴ and R⁵, taken together with the carbons that they are attached to, form an aryl ring;
R⁶ is H or C₁-C₆ alkyl;
R⁷ is H or C₁-C₆ alkyl;
R⁸ is H, C₁-C₆ alkyl, or (CH₂)ₘ(R⁹)₂;
R⁹ is H or C₁-C₆ alkyl;
each n is independently at each occurrence 0, 1, 2, 3, or 4; and
each m is independently at each occurrence 1, 2, 3, or 4.

3. The dye of claim 2, wherein
R¹ is H, methyl, ethyl, n-butyl, t-butyl, (CH₂)₃CF₃, CH₂CO₂R⁷, or CH₂CN, or 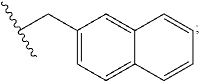 [SMILES: *Cc1ccc2ccccc2c1]
R^{2a}, R^{2b}, and R^{2c} are each independently H, methyl, ethyl, n-butyl, t-butyl, or CO₂R⁷;
R³ is H;
R⁴ is methyl and R⁵ is CN or R⁴ and R⁵, taken together with the carbons that they are attached to, form an aryl ring;
R⁶ is H or ethyl; and
R⁷ is H or C₁-C₆ alkyl.

4. The dye of claim 3, wherein
R¹ is H, methyl, ethyl, n-butyl, or t-butyl;
R^{2a}, R^{2b}, and R^{2c} are each independently H, methyl, ethyl, n-butyl, or t-butyl;
R³ is H;
R⁴ is methyl;
R⁵ is CN; and
R⁶ is H or ethyl.

5. The dye of claim 1 wherein the dye is
5-((4-(tert-butyl)-1H-pyrrol-2-yl)methylene)-1-ethyl-4-methyl-2,6-dioxo-1,2,5,6-tetrahydropyridine-3-carbonitrile;
5-((3,5-dimethyl-1H-pyrrol-2-yl)methylene)-1-ethyl-4-methyl-2,6-dioxo-1,2,5,6-tetrahydropyridine-3-carbonitrile;
5-((1H-pyrrol-2-yl)methylene)-1-ethyl-4-methyl-2,6-dioxo-1,2,5,6-tetrahydropyridine-3-carbonitrile;
ethyl-5-((5-cyano-1-ethyl-4-methyl-2,6-dioxo-1,6-dihydropyridin-3(2H)-ylidene)methyl)-2,4-dimethyl-1H-pyrrole-3-carboxylate;
5-((5-cyano-1-ethyl-4-methyl-2,6-dioxo-1,6-dihydropyridin-3(2H)-ylidene)methyl)-2,4-dimethyl-1H-pyrrole-3-carboxylic acid;
5-((5-cyano-1-ethyl-4-methyl-2,6-dioxo-1,6-dihydropyridin-3(2H)-ylidene)methyl)-N-(2-(diethylamino)ethyl)-2,4-dimethyl-1H-pyrrole-3-carboxamide;
ethyl-5-((5-cyano-1-ethyl-4-methyl-2,6-dioxo-1,6-dihydropyridin-3(2H)-ylidene)methyl)-1H-pyrrole-2-carboxylate;
5-((1H-pyrrol-2-yl)methylene)-4-methyl-2,6-dioxo-1,2,5,6-tetrahydropyridine-3-carbonitrile;
tetrahydropyridine-3-carbonitrile;
5-((3,5-dimethyl-1H-pyrrol-2-yl)methylene)-4-methyl-2,6-dioxo-1,2,5,6-tetrahydropyridine-3-carbonitrile;
1-ethyl-4-methyl-5-((1-methyl-1H-pyrrol-2-yl)methylene)-2,6-dioxo-1,2,5,6-tetrahydropyridine-3-carbonitrile;
5-((4-(tert-butyl)-1-butyl-1H-pyrrol-2-yl)methylene)-1-ethyl-4-methyl-2,6-dioxo-1,2,5,6-tetrahydropyridine-3-carbonitrile;
5-((4-(tert-butyl)-1-(naphthalen-2-ylmethyl)-1H-pyrrol-2-yl)methylene)-1-ethyl-4-methyl-2,6-dioxo-1,2,5,6-tetrahydropyridine-3-carbonitrile;
ethyl (Z)-5-((5-cyano-4-methyl-2,6-dioxo-1,6-dihydropyridin-3(2H)-ylidene)methyl)-1-(cyanomethyl)-2,4-dimethyl-1H-pyrrole-3-carboxylate;
4-((1H-pyrrol-2-yl)methylene)isoquinoline-1,3(2H,4H)-dione;
4-((4-(tert-butyl)-1H-pyrrol-2-yl)methylene)isoquinoline-1,3(2H,4H)-dione;
4-((3,5-dimethyl-1H-pyrrol-2-yl)methylene)isoquinoline-1,3(2H,4H)-dione;
5-((4-(tert-butyl)-1-(4,4,4-trifluorobutyl)-1H-pyrrol-2-yl)methylene)-1-ethyl-4-methyl-2,6-dioxo-1,2,5,6-tetrahydropyridine-3-carbonitrile;
5-((4-(tert-butyl)-1-(4,4,4-trifluorobutyl)-1H-pyrrol-2-yl)methylene)-4-methyl-2,6-dioxo-1,2,5,6-tetrahydropyridine-3-carbonitrile;
ethyl (Z)-2-(4-(tert-butyl)-2-((5-cyano-1-ethyl-4-methyl-2,6-dioxo-1,6-dihydropyridin-3 (2H)-ylidene)methyl)-1H-pyrrol-1-yl) acetate; or
5-((4-(tert-butyl)-1-(cyanomethyl)-1H-pyrrol-2-yl)methylene)-4-methyl-2,6-dioxo-1,2,5,6-tetrahydropyridine-3-carbonitrile.

6. The dye of claim 1 wherein the dye is
(Z)-5-((4-(tert-butyl)-1H-pyrrol-2-yl)methylene)-1-ethyl-4-methyl-2,6-dioxo-1,2,5,6-tetrahydropyridine-3-carbonitrile;
(Z)-5-((3,5-dimethyl-1H-pyrrol-2-yl)methylene)-1-ethyl-4-methyl-2,6-dioxo-1,2,5,6-tetrahydropyridine-3-carbonitrile;
(Z)-5-((1H-pyrrol-2-yl)methylene)-1-ethyl-4-methyl-2,6-dioxo-1,2,5,6-tetrahydropyridine-3-carbonitrile;
ethyl (Z)-5-((5-cyano-1-ethyl-4-methyl-2,6-dioxo-1,6-dihydropyridin-3(2H)-ylidene)methyl)-2,4-dimethyl-1H-pyrrole-3-carboxylate;
(Z)-5-((5-cyano-1-ethyl-4-methyl-2,6-dioxo-1,6-dihydropyridin-3(2H)-ylidene)methyl)-2,4-dimethyl-1H-pyrrole-3-carboxylic acid;
(Z)-5-((5-cyano-1-ethyl-4-methyl-2,6-dioxo-1,6-dihydropyridin-3(2H)-ylidene)methyl)-N-(2-(diethylamino)ethyl)-2,4-dimethyl-1H-pyrrole-3-carboxamide;
ethyl (Z)-5-((5-cyano-1-ethyl-4-methyl-2,6-dioxo-1,6-dihydropyridin-3(2H)-ylidene)methyl)-1H-pyrrole-2-carboxylate;
(Z)-5-((1H-pyrrol-2-yl)methylene)-4-methyl-2,6-dioxo-1,2,5,6-tetrahydropyridine-3-carbonitrile;
(Z)-5-((4-(tert-butyl)-1H-pyrrol-2-yl)methylene)-4-methyl-2,6-dioxo-1,2,5,6-tetrahydropyridine-3-carbonitrile;
(Z)-5-((3,5-dimethyl-1H-pyrrol-2-yl)methylene)-4-methyl-2,6-dioxo-1,2,5,6-tetrahydropyridine-3-carbonitrile;
(Z)-1-ethyl-4-methyl-5-((1-methyl-1H-pyrrol-2-yl)methylene)-2,6-dioxo-1,2,5,6-tetrahydropyridine-3-carbonitrile;
(Z)-5-((4-(tert-butyl)-1-butyl-1H-pyrrol-2-yl)methylene)-1-ethyl-4-methyl-2,6-dioxo-1,2,5,6-tetrahydropyridine-3-carbonitrile;
(Z)-5-((4-(tert-butyl)-1-(naphthalen-2-ylmethyl)-1H-pyrrol-2-yl)methylene)-1-ethyl-4-methyl-2,6-dioxo-1,2,5,6-tetrahydropyridine-3-carbonitrile;
ethyl (Z)-5-((5-cyano-4-methyl-2,6-dioxo-1,6-dihydropyridin-3(2H)-ylidene)methyl)-1-(cyanomethyl)-2,4-dimethyl-1H-pyrrole-3-carboxylate;
(Z)-4-((1H-pyrrol-2-yl)methylene)isoquinoline-1,3(2H,4H)-dione;
(Z)-4-((4-(tert-butyl)-1H-pyrrol-2-yl)methylene)isoquinoline-1,3(2H,4H)-dione;
(Z)-4-((3,5-dimethyl-1H-pyrrol-2-yl)methylene)isoquinoline-1,3(2H,4H)-dione;
(Z)-5-((4-(tert-butyl)-1-(4,4,4-trifluorobutyl)-1H-pyrrol-2-yl)methylene)-1-ethyl-4-methyl-2,6-dioxo-1,2,5,6-tetrahydropyridine-3-carbonitrile;
(Z)-5-((4-(tert-butyl)-1-(4,4,4-trifluorobutyl)-1H-pyrrol-2-yl)methylene)-4-methyl-2,6-dioxo-1,2,5,6-tetrahydropyridine-3-carbonitrile;
ethyl (Z)-2-(4-(tert-butyl)-2-((5-cyano-1-ethyl-4-methyl-2,6-dioxo-1,6-dihydropyridin-3 (2H)-ylidene)methyl)-1H-pyrrol-1-yl) acetate; or
(Z)-5-((4-(tert-butyl)-1-(cyanomethyl)-1H-pyrrol-2-yl)methylene)-4-methyl-2,6-dioxo-1,2,5,6-tetrahydropyridine-3-carbonitrile.

7. The dye of claim 1 wherein the dye is
(E)-5-((4-(tert-butyl)-1H-pyrrol-2-yl)methylene)-1-ethyl-4-methyl-2,6-dioxo-1,2,5,6-tetrahydropyridine-3-carbonitrile;
(E)-5-((3,5-dimethyl-1H-pyrrol-2-yl)methylene)-1-ethyl-4-methyl-2,6-dioxo-1,2,5,6-tetrahydropyridine-3-carbonitrile;
(E)-5-((1H-pyrrol-2-yl)methylene)-1-ethyl-4-methyl-2,6-dioxo-1,2,5,6-tetrahydropyridine-3-carbonitrile;
ethyl (Z)-5-((5-cyano-1-ethyl-4-methyl-2,6-dioxo-1,6-dihydropyridin-3(2H)-ylidene)methyl)-2,4-dimethyl-1H-pyrrole-3-carboxylate;
(E)-5-((5-cyano-1-ethyl-4-methyl-2,6-dioxo-1,6-dihydropyridin-3(2H)-ylidene)methyl)-2,4-dimethyl-1H-pyrrole-3-carboxylic acid;
(E)-5-((5-cyano-1-ethyl-4-methyl-2,6-dioxo-1,6-dihydropyridin-3(2H)-ylidene)methyl)-N-(2-(diethylamino)ethyl)-2,4-dimethyl-1H-pyrrole-3-carboxamide;
ethyl (E)-5-((5-cyano-1-ethyl-4-methyl-2,6-dioxo-1,6-dihydropyridin-3(2H)-ylidene)methyl)-1H-pyrrole-2-carboxylate;
(E)-5-((1H-pyrrol-2-yl)methylene)-4-methyl-2,6-dioxo-1,2,5,6-tetrahydropyridine-3-carbonitrile;
(E)-5-((4-(tert-butyl)-1H-pyrrol-2-yl)methylene)-4-methyl-2,6-dioxo-1,2,5,6-tetrahydropyridine-3-carbonitrile;
(E)-5-((3,5-dimethyl-1H-pyrrol-2-yl)methylene)-4-methyl-2,6-dioxo-1,2,5,6-tetrahydropyridine-3-carbonitrile;
(E)-1-ethyl-4-methyl-5-((1-methyl-1H-pyrrol-2-yl)methylene)-2,6-dioxo-1,2,5,6-tetrahydropyridine-3-carbonitrile;
(E)-5-((4-(tert-butyl)-1-butyl-1H-pyrrol-2-yl)methylene)-1-ethyl-4-methyl-2,6-dioxo-1,2,5,6-tetrahydropyridine-3-carbonitrile;
(E)-5-((4-(tert-butyl)-1-(naphthalen-2-ylmethyl)-1H-pyrrol-2-yl)methylene)-1-ethyl-4-methyl-2,6-dioxo-1,2,5,6-tetrahydropyridine-3-carbonitrile;
ethyl (E)-5-((5-cyano-4-methyl-2,6-dioxo-1,6-dihydropyridin-3(2H)-ylidene)methyl)-1-(cyanomethyl)-2,4-dimethyl-1H-pyrrole-3-carboxylate;
(E)-4-((1H-pyrrol-2-yl)methylene)isoquinoline-1,3(2H,4H)-dione;
(E)-4-((4-(tert-butyl)-1H-pyrrol-2-yl)methylene)isoquinoline-1,3(2H,4H)-dione;
(E)-4-((3,5-dimethyl-1H-pyrrol-2-yl)methylene)isoquinoline-1,3(2H,4H)-dione;
(E)-5-((4-(tert-butyl)-1-(4,4,4-trifluorobutyl)-1H-pyrrol-2-yl)methylene)-1-ethyl-4-methyl-2,6-dioxo-1,2,5,6-tetrahydropyridine-3-carbonitrile;
(E)-5-((4-(tert-butyl)-1-(4,4,4-trifluorobutyl)-1H-pyrrol-2-yl)methylene)-4-methyl-2,6-dioxo-1,2,5,6-tetrahydropyridine-3-carbonitrile;
ethyl (E)-2-(4-(tert-butyl)-2-((5-cyano-1-ethyl-4-methyl-2,6-dioxo-1,6-dihydropyridin-3 (2H)-ylidene)methyl)-1H-pyrrol-1-yl) acetate; or
(E)-5-((4-(tert-butyl)-1-(cyanomethyl)-1H-pyrrol-2-yl)methylene)-4-methyl-2,6-dioxo-1,2,5,6-tetrahydropyridine-3-carbonitrile.

8. A dyed article comprising a polymer material and at least one dye according to claim 1.

9. The dyed article of claim 8, wherein the at least one dye of Formula I is selected from the group consisting of
5-((3,5-dimethyl-1H-pyrrol-2-yl)methylene)-1-ethyl-4-methyl-2,6-dioxo-1,2,5,6-tetrahydropyridine-3-carbonitrile;
5-((1H-pyrrol-2-yl)methylene)-4-methyl-2,6-dioxo-1,2,5,6-tetrahydropyridine-3-carbonitrile;
5-((1H-pyrrol-2-yl)methylene)-1-ethyl-4-methyl-2,6-dioxo-1,2,5,6-tetrahydropyridine-3-carbonitrile;
5-((4-(tert-butyl)-1H-pyrrol-2-yl)methylene)-1-ethyl-4-methyl-2,6-dioxo-1,2,5,6-tetrahydropyridine-3-carbonitrile;
5-((4-(tert-butyl)-1H-pyrrol-2-yl)methylene)-4-methyl-2,6-dioxo-1,2,5,6-tetrahydropyridine-3-carbonitrile;
5-((3,5-dimethyl-1H-pyrrol-2-yl)methylene)-4-methyl-2,6-dioxo-1,2,5,6-tetrahydropyridine-3-carbonitrile;
4-((1H-pyrrol-2-yl)methylene)isoquinoline-1,3(2H,4H)-dione;
4-((4-(tert-butyl)-1H-pyrrol-2-yl)methylene)isoquinoline-1,3(2H,4H)-dione; and
4-((3,5-dimethyl-1H-pyrrol-2-yl)methylene)isoquinoline-1,3(2H,4H)-dione as exclusively the (Z) isomer, exclusively the (E) isomer, or a combination of both the (Z) and the (E) isomer.

10. The dyed article of claim 8, wherein the at least one dye of Formula I is selected from the group consisting of:
5-((3,5-dimethyl-1H-pyrrol-2-yl)methylene)-1-ethyl-4-methyl-2,6-dioxo-1,2,5,6-tetrahydropyridine-3-carbonitrile;
5-((1H-pyrrol-2-yl)methylene)-4-methyl-2,6-dioxo-1,2,5,6-tetrahydropyridine-3-carbonitrile;
5-((1H-pyrrol-2-yl)methylene)-1-ethyl-4-methyl-2,6-dioxo-1,2,5,6-tetrahydropyridine-3-carbonitrile;
5-((3,5-dimethyl-1H-pyrrol-2-yl)methylene)-4-methyl-2,6-dioxo-1,2,5,6-tetrahydropyridine-3-carbonitrile;
4-((1H-pyrrol-2-yl)methylene)isoquinoline-1,3(2H,4H)-dione; and
4-((3,5-dimethyl-1H-pyrrol-2-yl)methylene)isoquinoline-1,3(2H,4H)-dione
as exclusively the (Z) isomer, exclusively the (E) isomer, or a combination of both the (Z) and the (E) isomer.

11. The dyed article of claim 8, wherein the dyed article is in the form of a shield, a lens, a window, a lid, a cover, a case, a plaque, a sheet, a film, clothing, a panel, and a curtain.

12. The dyed article of claim 8, wherein the polymer material is selected from the group consisting of an acrylic resin, a styrenic resin, a cellulosic resin, a polyamide resin, a polycarbonate resin, a polyester resin, a polyethylene resin, a polyimide resin, and a polyurethane resin.

13. The dyed article of claim 8, wherein the polymer material is crosslinked.

14. The dyed article of claim 8, wherein the dyed article has an optical density of at least about 12 from about 430 nm to about 470 nm and internal visual luminous transmission of no more than about 85% using the methods described in ANSI Standard Z80.3 and Illuminant C.

15. A process of preparing the dyed article of claim 8, comprising coating, casting, extruding, or molding the polymer material together with the one or more dyes.

16. A method for making the dye of Formula I, the method comprising: 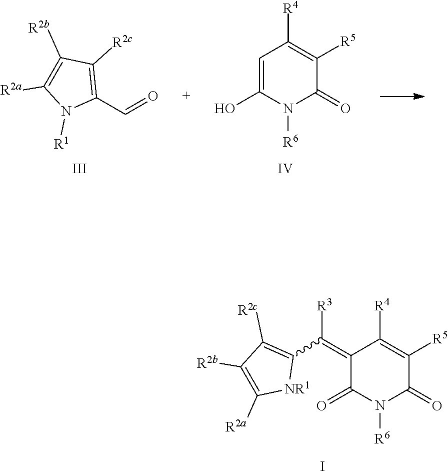
reacting a compound of Formula III with a compound of Formula IV in a solvent in the presence of a base catalyst while maintaining a reaction temperature of about room temperature to about 50° C., wherein
R¹ is H, C₁-C₆ alkyl, C₃-C₆ cycloalkyl, C₁-C₆ haloalkyl, (CH₂)ₙCO₂R⁷, (CH₂)ₙC(O)NHR⁷, alkylene-CN, or alkylene-aryl; and
R^{2a}, R^{2b}, and R^{2c} are each independently H, halo, C₁-C₆ alkyl, C₃-C₆ cycloalkyl, aryl, (CH₂)ₙCO₂R⁷, or C(O)NHR⁸;
R³ is H, C₁-C₆ alkyl, C₃-C₆ cycloalkyl, C₁-C₆ haloalkyl, aryl, (CH₂)ₙCO₂R⁷, or (CH₂)ₙC(O)NHR⁷;
R⁴ is H, C₁-C₆ alkyl, C₃-C₆ cycloalkyl, C₁-C₆ haloalkyl, aryl, (CH₂)ₙCO₂R⁷, or (CH₂)ₙC(O)NHR⁷ and R⁵ is CN; or R⁴ and R⁵, taken together with the carbons that they are attached to, form an aryl ring;
R⁶ is H, C₁-C₆ alkyl, C₃-C₆ cycloalkyl, C₁-C₆ haloalkyl, aryl, alkylene-CO₂R⁷, or alkylene-C(O) NHR⁷;
R⁷ is H or C₁-C₆ alkyl;
R⁸ is H, C₁-C₆ alkyl, or (CH₂)ₘ(R⁹)₂;
R⁹ is H, C₁-C₆ alkyl;
each n is independently at each occurrence 0, 1, 2, 3, or 4; and
m is 1, 2, 3, or 4, and
isolating the compound of Formula I.

17. The method of claim 16, wherein the solvent is ethanol.

18. The method of claim 16, wherein the base catalyst is piperidine.
